(19) United States
(12) Patent Application Publication
(10) Pub. No.: US 2004/0142122 A1
(43) Pub. Date: Jul. 22, 2004

(54) Ink jet printing sheet

(75) Inventors: Toshiki Taguchi, Shizuoka (JP); Manabu Ogawa, Shizuoka (JP); Yoshihisa Tsukada, Kanagawa (JP); Masanobu Takashima, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/752,564

(22) Filed: Jan. 8, 2004

(30) Foreign Application Priority Data
Jan. 8, 2003 (JP) P. 2003-002310
Jan. 8, 2003 (JP) P. 2003-002312

(51) Int. Cl. B32B 3/00

(52) U.S. Cl. 428/32.1

(57) ABSTRACT

An ink jet printing sheet comprising a colorant-receiving layer and a support, wherein the colorant-receiving layer contains a metal chelating compound having an oil-soluble group having 6 or more carbon atoms or an amino acid derivative having an oil-soluble group having 6 or more carbon atoms.

The present invention relates to a material to be printed which is supplied to an ink jet printing employing a liquid ink such as an aqueous ink (employing a dye or a pigment as a colorant) and an oily ink as well as a solid ink which is a solid at an ambient temperature but becomes melted and liquefied upon printing, and more particularly, to an ink jet printing sheet having an excellent image durability under a highly humid condition.

### BACKGROUND OF THE INVENTION

Recently, various data processing systems were developed in response to a rapid advancement of the industries of informantial technology, and the recording methods and devices for such data processing systems were also developed and brought into practical uses.

Among such recording methods, an ink jet printing method has increasingly been employed not only in offices but also in homes because of its advantageous properties such as the capability of being applied to various materials to be printed, a relatively less expensive compact-sized hardware (device) and a highly reduced noise upon operating.

Also in response to a higher resolution of an ink jet printer in these days, it becomes possible to produce a highly defined printed matter which is a so-called photo-like print, and such a promoted advancement of the hardwares (devices) leaded to the development of various printing sheets for the ink jet printing.

In general, the characteristics essential for such an ink jet printing sheet are (1) a rapid drying property (a high ink absorbing rate), (2) an appropriate and uniform ink dot size (absence of oozing out), (3) a satisfactory particle condition, (4) a highly true circle of a dot, (5) a highly intense color, (6) a high chroma (without darkening), (7) satisfactory water-proof, light resistance and ozone resistance of a printed part, (8) a high whiteness of a printing sheet, (9) a satisfactory storage performance of a printing sheet (without undergoing any yellowing after a prolonged storage period and without undergoing any oozing after a prolonged storage (satisfactory resistance to retarded oozing out), (10) a less deformable and satisfactorily stable size (sufficiently low curling behavior), (11) a satisfactory running over a hardware and the like.

In addition to the characteristics listed above, a gloss, a surface smoothness and a photographic paper-like tone analogous to that of a silver halide photograph are required in the use of a photo-glossy paper employed for the purpose of obtaining a photo-like printed matter having a high image quality.

For the purpose of improving the characteristics listed above, a ink jet printing sheet having a porous structure in a colorant-receiving layer has recently been developed and brought into a practical use. Such an ink jet printing sheet has a high ink-receiving capacity (rapid drying performance) and exhibits an excellent gloss because of its porous structure.

For example, JP-A-10-119423 or 10-217601 proposed an ink jet printing sheet having on its support a colorant-receiving layer comprising a fine inorganic pigment particle and a water-soluble resin and having a high void volume.

Such a printing sheet, especially an ink jet printing sheet having a colorant receiving layer formed as a porous structure employing a silica as an inorganic pigment particle, exhibits, by virtue of its structure, an excellent ink absorbing performance and a high ink-receiving performance capable of providing an image of a high resolution and exhibits a high gloss.

However, a problematic decoloration of a printed image may occur over a prolonged period because of an atmospheric trace gas component, especially by ozone. A printing material comprising a colorant-receiving layer having a porous structure readily undergoes the atmospheric ozone-induced decoloration since it has a large number of voids. Accordingly, the resistance to the atmospheric ozone (anti-ozone property) is a highly significant property required in a printing material having a colorant-receiving layer having a porous structure described above.

Also since a printed image contains a water-soluble dye, it has a disadvantageous, tendency of blurring under a highly humid condition. In order to overcome this disadvantage, we made an effort and finally discovered that a chelating compound having in its molecule an oil-soluble group or an amino acid having an oil-soluble group is effective.

SUMMARY OF THE INVENTION

An objective of the invention is to provide an ink jet printing sheet exhibiting a less blurring even under a highly humid condition and a method for producing said printing sheet.

The objective described above has been accomplish d by the following means.

1) An ink jet printing sheet containing a colorant-receiving layer and a support wherein said colorant-receiving layer comprises a metal chelating compound having an oil-soluble group having 6 or more carbon atoms or an amino derivative having an oil-soluble group having 6 or more carbon atoms.

2) An ink jet printing sheet according to the above-mentioned 1) wherein said colorant-receiving layer further comprises a water-soluble resin.

3) An ink jet printing sheet according to the above-mentioned 1) or 2) wherein said water-soluble resin is at least one selected from polyvinyl alcohol-based resins, cellulose-based resins, ether bond-carrying resins, carbamoyl group-carrying resins, carboxyl group-carrying resin and gelatins.

4) An ink jet printing sheet according to any of the above-mentioned 1) to 3) wherein said colorant-receiving layer further comprises a microparticle.

5) An ink jet printing sheet according to the above-mentioned 4) wherein said microparticle is at least one selected from a silica microparticle, colloidal silica, alumina microparticle and pseudo-boehmite.

6) An ink jet printing sheet according to any of The above-mentioned 1) to 5) wherein said colorant-receiving layer comprises a crosslinking agent capable of crosslinking a water-soluble resin.

7) An ink jet printing sheet according to any of The above-mentioned 1) to 6) wherein said colorant-receiving layer further comprises a mordant.

8) An ink jet printing sheet according to any of The above-mentioned 1) to 7) wherein said colorant-receiving layer is a layer formed as a result of a crosslinking curing of a coating layer formed by applying a coating solution comprising at least a microparticle, a water-soluble resin and a crosslinking agent, and also wherein said crosslinking curing is conducted by applying a basic solution whose pH is 8 or higher onto said coating layer or a coating film (1) simultaneously with the application of said coating solution, or (2) during the course of the drying of the coating layer formed by applying said coating solution but before the time when said coating layer exhibits a reduced rate drying.

9) A method for producing an ink jet printing sheet wherein said colorant-receiving layer allows a coating layer formed by applying a coating solution comprising at least a microparticle, a water-soluble resin and a crosslinking agent to be cured by crosslinking, and also wherein in said crosslinking curing step a basic solution whose pH is 8 or high r is applied onto said coating layer or a coating film (1) simultaneously with the application of said coating solution, or (2) during the course of the drying of the coating layer formed by applying said coating solution but before the time when said coating layer exhibits a reduced rate drying.

### DETAILED DESCRIPTION OF THE INVENTION

The invention is detailed below.

An ink jet printing sheet of the invention characteristically comprises a metal chelating compound having an oil-soluble group or an amino acid derivative having an oil-soluble group.

[Metal Chelating Compound Having an Oil-Soluble Group]

As used herein, a metal is mainly a transition metal. A chelating compound is a compound capable of forming an ionic bond or a coordinate bond with a metal. A compound having such effects may for example be an organic compound having a free functional group capable of forming an ionic bond with a metal bond. Such a free functional group may for example be a hydroxy group, thiol group, sulfoanmide group, imido group, carboxyl group, sulfo group, phosphate group, phosphonate group and the like. A compound having a group having a non-covalent electron pair capable of forming a coordinate bond may also be exemplified. Such a group may for example be an ether group, thioether group, amino group and a nitrogen atom in a heterocyclic ring.

It is especially preferred to use a chelating agent having a combination of the effects of the compounds having the groups listed above.

A metal chelating compound may for example those listed below.

Those which may be exemplified are aliphatic or aromatic carboxylic acids, dicarboxylic acids, tricarboxylic acids or carboxylic acids of higher valencies, oxycarboxylic acids, ketocarboxylic acids, thiocarboxylic acids, aromatic aldehydes, amine-based compounds, diamine compounds, polyamine compounds, aminopolyearboxylic acids, nitrilotriacetic acid derivatives, ethylene dimine polycarboxylic acids, amino acids, heterocyclic carboxylic acids, heterocycles, pyrimidines, nucleosides, purine bases, β-diketones, oxynes and the like. Among those listed above, aminopolycarboxylic acids (preferably ethylene diamine polycarboxylic acids) or a chelating agent whose nitrogen lone pair can serve as a donor.

Such a compound may for example be any of numerous known compounds including phthalic acid, phthalonic acid, salicylic acid, thiosalicylic acid, picolic acid, quinolic acid, 2,6-dipicolic acid, biphenyl-2,2′-dicarboxylic acid, oxine, 2-hydroxypyridine, pyrazinecarboxylic acid, ethylene diamine, diethylene triamine, triethylene tetramine, glycine, 3-aminopropionic acid, iminodiacetic acid, iminotriacetic acid, ethylene diamine tetraacetic acid, propylene diamine tetraacetic acid, butylene diamine tetraacetic acid, 1,10-phenanthroline and the like. In addition to those listed above, examples of the chelating compounds can be found also in a complexan listing of “EDTA-complexan chemistry”, ed. by K.UENO (NANKODO, published on Apr. 15, 1977) (see its appendix) and an appendix (stability constant listing) of “Metal chelates [III]” ed. by K.UENO (NANKODO, published on Feb. 20, 1967), among which a metal chelating compound having an oil-soluble group having 6 or more carbon atoms is employed preferably in the invention.

A preferred amino carboxylic acid is characterized by its moiety ═N—CH₂COOH(X1), ═N—CH₂CH₂COOH(X2), ═N—CH(CH₃)COOH(X3) and the like, and those preferred are the compounds represented by RₖNX wherein X is X1, X2 or X3, Rₖ—NX—CH₂CH₂—NX—Rₖ, Rₖ—NX—CH₂CH₂—NX₂ and X₂N—R—NX₂. Rₖ represents an oil-soluble group having 6 to 40 carbon atoms (preferably 8 to 20 carbon atoms), while R represents an aklyene group having 6 to 40 carbon atoms (preferably 8 to 20 carbon atoms).

A compound having an oil-soluble group having 6 or more carbon atoms in any of the polymeric compounds listed below (or into which an oil-soluble group having 6 or more carbon atoms has been introduced if not having such a group) can preferably be employed.

While such a compound may be selected from various polymers such as a polymeric compound having a functional group capable of interacting with a metal ion, i.e., the above-mentioned hydroxy group, thiol group, sulfoanmide group, imido group, carboxyl group, sulfo group, phosphate group, phosphonate group, ether group, thioether group, amino group, a nitrogen atom in a heterocyclic ring; if classified based on the backbone structure of the polymeric compound, a vinyl polymerization polymer, polyether-type polymer, polyester-type polymer, polyaromatics (including heterocycles), polyamine-type polymer and the like, and in the invention, those employed preferably are vinyl polymerization polymers, polyether-type polymers and polyamine-type polymers; especially preferred being a water-soluble polymer capable of being existing as an aqueous solution of 10% by mass or higher, a microparticulate aqueous dispersion polymer, a latex polymer produced by an emulsion polymerization. In addition, a polymer having as its moiety a group serving as a chelating agent described above is employed most preferably.

Typically, the polymers may for example be polyacrylic acids, polymethacrylic acids, polyvinylamines, polyallylamines, polyimines, polyvinyl alcohols, polyhydroxyethyl acrylates, polyhydroxyethyl methacrylates, polyethylene glycols, polyvinylpyridines, quaternary ammonium group-substituted polystyrene derivatives, as well as copolymers thereof or copolymers with monomers having chelating agent structures and copolymers with various known monomers.

A chelating compound employed in the invention is characterized by its substituent which is an oil-soluble group having 6 or more carbon atoms. Such an oil-soluble group may for example be an alkyl group, aryl group and the like, as well as a group having a moiety thereof. The number of the oil-soluble groups is 1 or 10 (preferably 1 to 4, more particularly 1 or 2, especially 1), and the number of the carbon atoms per oil-soluble group is preferably 6 to 40, more preferably 8 to 20.

In the case of a low molecular weight compound, one having 1 to 4 oil-soluble groups (preferably 1 or 2, especially 1) in its molecule is a preferred compound. In the case of a high molecular weight compound, such an oil-soluble group may be contained in a monomer unit having a chelating property, or may be contained in a monomer unit which is copolymerized with the monomer unit having the chelating property. In the case of the copolymerization, the monomer unit having an oil-soluble group is present in a polymerization molar ratio of 0.01 to 99%, preferably 0.1 to 90% based on the entire being 100%.

An inventive chelating compound may be substituted with various substituents in addition to a functional group capable of interacting with a metal ion described above and an oil-soluble group. Such a substituent (which may also serve as a functional group capable of interacting with a metal ion) may be substituted separately from an oil-soluble group, or may be substituted on the oil-soluble group. Examples are alkyl groups (preferably having 1 to 20 carbon atoms, more preferably 1 to 12 carbon atoms, particularly 1 to 8 carbon atoms, such as methyl, ethyl, isopropyl, t-butyl, n-octyl, n-decyl, n-hexadecyl, cyclopropyl, cyclopentyl, cyclohexyl and the like), alkenyl groups (preferably having 2 to 20 carbon atoms, more preferably 2 to 12 carbon atoms, particularly 2 to 8 carbon atoms, such as vinyl, allyl, 2-butenyl, 3-pentenyl and the like), alkynyl groups (preferably having 2 to 20 carbon atoms, more preferably 2 to 12 carbon atoms, particularly 2 to 8 carbon atoms, such as propargyl, 3-pentynyl and the like), aryl groups (preferably having 6 to 30 carbon atoms, more preferably 6 to 20 carbon atoms, particularly 6 to 12 carbon atoms, such as phenyl, p-methylphenyl, naphthyl and the like), amino groups (preferably having 0 to 20 carbon atoms, more preferably 0 to 12 carbon atoms, particularly 0 to 6 carbon atoms, such as amino, methylamino, dimethylamino, dietylamino, diphenylamino, dibenzylamino and the like), alkoxy groups (preferably having 1 to 20 carbon atoms, more preferably 1 to 12 carbon atoms, particularly 1 to 8 carbon atoms, such as methoxy, ethoxy, butoxy and the like), aryloxy groups (preferably having 6 to 20 carbon atoms, more preferably 6 to 16 carbon atoms, particularly 6 to 12 carbon atoms, such as phenyloxy, 2-naphtyloxy and the like), acyl groups (preferably having 1 to 20 carbon atoms, more preferably 1 to 16 carbon atoms, particularly 1 to 12 carbon atoms, such as acetyl, benzoyl, formyl, pivaloyl and the like), alkoxycarbonyl groups (preferably having 2 to 20 carbon atoms, more preferably 2 to 16 carbon atoms, particularly 2 to 12 carbon atoms, such an methoxycarbonyl, ethoxycarbonyl and the like), aryloxycarbonyl groups (preferably having 7 to 20 carbon atoms, more preferably 7 to 16 carbon atoms, particularly 7 to 10 carbon atoms, such as phenyloxycarbonyl and the like), acyloxy groups (preferably having 2 to 20 carbon atoms, more preferably 2 to 16 carbon atoms, particularly 2 to 10 carbon atoms, such as acetoxy, benzoyloxy and the like), acylamino groups (preferably having 2 to 20 carbon atoms, more preferably 2 to 16 carbon atoms, particularly 2 to 10 carbon atoms, such as acetylamino, benzoylamino and the like), alkoxycarbonylamino groups (preferably having 2 to 20 carbon atoms, more preferably 2 to 16 carbon atoms, particularly 2 to 12 carbon atoms, such as methoxycarbonylamino and the like), aryloxycarbonylamino groups (preferably having 7 to 20 carbon atoms, more preferably 7 to 16 carbon atoms, particularly 7 to 12 carbon atoms, such as phenyloxycarbonyl amino and the like), sulfonylamino groups (preferably having 1 to 20 carbon atoms, more preferably 1 to 16 carbon atoms, particularly 1 to 12 carbon atoms, such as methanesulfonylamino, benzenesulfonylamino and the like), sulfamoyl groups (preferably having 0 to 20 carbon atoms, more preferably 0 to 16 carbon atoms, particularly 0 to 12 carbon atoms, such as sulfamoyl, methylsulfamoyl, dimethylsulfamoyl, phenylsulfamoyl and the like), carbamoyl groups (preferably having 1 to 20 carbon atoms, more preferably 1 to 16 carbon atoms, particularly 1 to 12 carbon atoms, such as carbamoyl, methylcarbamoyl, diethylcarbamoyl, phenylcarbamoyl and the like), alkylthio groups (preferably having 1 to 20 carbon atoms, more preferably 1 to 16 carbon atoms, particularly 1 to 12 carbon atoms, such as methylthio, ethylthic and the like), arylthio groups (preferably having 6 to 20 carbon atoms, more preferably 6 to 16 carbon atoms, particularly 6 to 12 carbon atoms, such as phenylthio and the like), sulfonyl groups (preferably having 1 to 20 carbon atoms, more preferably 1 to 16 carbon atoms, particularly 1 to 12 carbon atoms, such as mesyl, tosyl and the like), sulfinyl groups (preferably having 1 to 20 carbon atoms, more preferably 1 to 16 carbon atoms, particularly 1 to 12 carbon atoms, such as methanesulfinyl, benzenesulfinyl and the like), ureido groups (preferably having 1 to 20 carbon atoms, more preferably 1 to 16 carbon atoms, particularly 1 to 12 carbon atoms, such as ureido, methylureido, phenylureido and the like), phosphoramide groups (preferably having 1 to 20 carbon atoms, more preferably 1 to 16 carbon atoms, particularly 1 to 12 carbon atoms, such as diethylphosphoramide, phenylphosphoramide and the like), hydroxy group, mercapto group, halogen atom (such as fluorine atom, chlorine atom, bromine atom, iodine atom), cyano group, sulfo group, carboxyl group, nitro group, hydroxam group, sulfino group, hydrazino group, imino group, heterocyclic group (preferably having 1 to 30 carbon atoms, more preferably 1 to 12 carbon atoms with beteroatoms such as nitrogen atoms, oxygen atoms and sulfur atoms, and typically, imidazolyl, pyridyl, quinolyl, furyl, thienyl, piperidyl, morpholino, benzoxazolyl, benzoimidazolyl, benzothiazolyl, carbazolyl, azepinyl and the like), silyl groups (preferably having 3 to 40 carbon atoms, more preferably 3 to 30 carbon atoms, particularly 3 to 24 carbon atoms, such as trimethylsilyl, triphenylsilyl and the like) and the like. Any of these substituents may further be substituted. When two or more substituents are present, they may be same or different. If possible, they may be taken together to form a ring.

A preferred metal chelating compound of the invention is a compound represented by Formula (A):

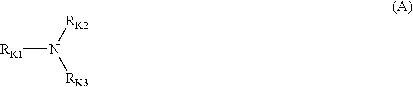

wherein Rₖ₁ is a substituted or unsubstituted alkyl group having 6 to 40 carbon atoms, each of Rₖ₂ and Rₖ₃ is a carboxylalkyl group (preferably a carboxyalkyl group having 1 to 4 carbon atoms, more preferably 1 to 2 carbon atoms, particularly 1 carbon atom), and the carboxyl group in the carboxylalkyl group may be in the form of a salt.

A unsubstituted alkyl group represented by Rₖ₁ may for example be an n-octyl group, n-dodecyl group, n-hexadecyl group, n-octyl group and the like. A substituted alkyl group represented by Rₖ₁ may for example be an alkoxycarbonyl group (for example, dodecyloxycarbonyl, hexadecyloxycarbonyl and the like), substituted amino group (in which the substituent may for example be a carboxmethyl group, such as an amino group substituted by two carboxyethyl groups) and the like.

The preferred examples of the compounds of the invention are those listed below, to which the invention is not limited.

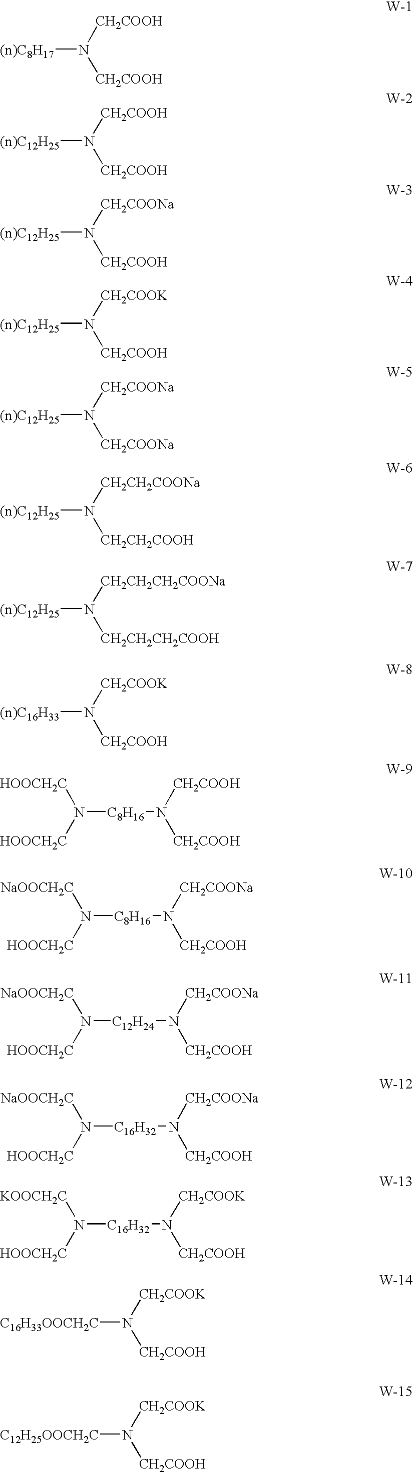

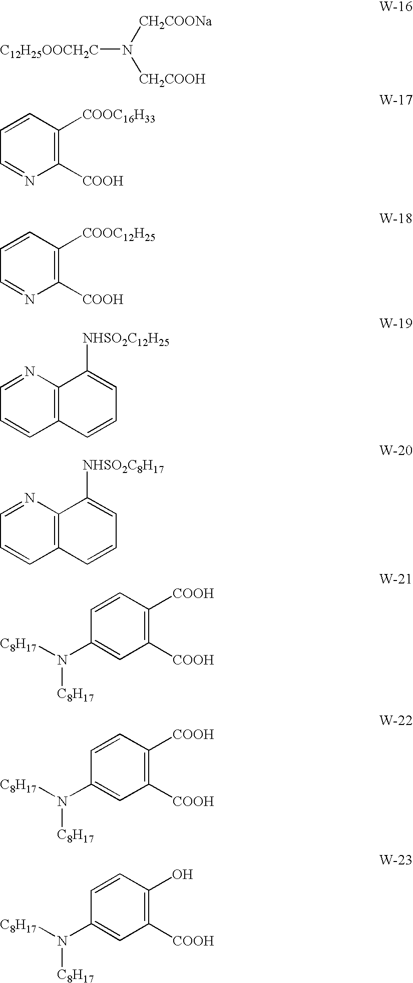

[Amino Acid Derivative Having an Oil-Soluble Group]

In addition to amino acids classified narrowly to the constituent units of a biological molecule, an amino acid, an used herein, means broadly a compound having in its molecule a basic nitrogen atom and a proton-releasing substituent.

Examples of the former as basic skeletal structures include glycine, lysine, tricine, bicine, alanine, valine, leucine, isoleucine, beta-alanine, serine, isoserine, threonine, praline, ornithine, glutamic acid, aspartic acid, inosinic acid, cysteine, methionine, taurine, cystine and the like.

Examples of the latter include various compounds such as aminoacetic acid, iminodiacetic acid, nitriloacetic acid, aminoadipic acid, pipecolic acid, picolic acid, nicotinic acid, quinolinic acid, phenylglycine, aminobenzoic acid, aminophthalic acid, dimethylaminobenzoic acid, diethylaminobenzoic acid and the like.

A polymeric compound having in its molecule an amino group and a carboxyl group or a sulfo group may also be employed preferably in the invention. When classifying on the basis of the polymer backbone structure, those exemplified are vinyl polymerization polymers, polyether-based polymers, polyester-based polymers, polyaromatics (including heterocycles), polyamine-based polymers and the like, with vinyl polymerization polymers, polyether-based polymers and polyamine-based polymers being employed preferably in the invention. Among those listed above, those especially preferred being a water-soluble polymer capable of being existing as an aqueous solution of 10% by mass or higher, a microparticulate aqueous dispersion polymer, a latex polymer produced by an emulsion polymerization. In addition, a polymer having as its moiety a group serving as a chelating agent described above is employed most preferably.

Typically, the polymers may for example be polyacrylic acids, polymethacrylic acids, polyvinylamines, polyallylamines, polyimes, polyvinyl alcohols, polyhydroxyethyl acrylates, polyhydroxyethyl methacrylates, polyethylene glycols, polyvinylpyridines, quaternary ammonium group-substituted polystyrene derivatives, as well as copolymers thereof or copolymers with monomers having amino acid structures and copolymers with various known monomers.

An amino acid derivative employed in the invention is characterized by its substituent which is an oil-soluble group having 6 or more carbon atoms on the above-mentioned amino acid and polymer. Such an oil-soluble group may for example be an alkyl group, aryl group and the like, as well as a group having a moiety thereof. The number of the carbon atoms is preferably 6 to 40, more preferably 8 to 20.

In the case of a low molecular weight compound, one having 1 to 10 oil-soluble groups (preferably 1 to 4, more preferably 1 or 2, especially 1) in its molecule is a preferred compound. In the case of a high molecular weight compound, such an oil-soluble group may be contained in an amino acid monomer unit, or may be contained in a monomer unit which is copolymerized with the amino acid monomer unit. In the case of the copolymerization, the monomer unit having an oil-soluble group is present in a polymerization molar ratio of 0.01 to 99%, preferably 0.1 to 90% based on the entire being 100%.

An inventive amino acid derivative may be substituted with various substituents. in addition to an oil-soluble group described above. Such a substituent may be substituted separately from an oil-soluble group, or may be substituted on the oil-soluble group. Examples are alkyl groups (preferably having 1 to 20 carbon atoms, more preferably 1 to 12 carbon atoms, particularly 1 to 8 carbon atoms, such as methyl, ethyl, isopropyl, t-butyl, n-octyl, n-decyl, n-hexadecyl, cyclopropyl, cyclopentyl, cyclohexyl and the like), alkenyl groups (preferably having 2 to 20 carbon atoms, more preferably 2 to 12 carbon atoms, particularly 2 to 8 carbon atoms, such as vinyl, allyl, 2-butenyl, 3-pentenyl and the like), alkynyl groups (preferably having 2 to 20 carbon atoms, more preferably 2 to 12 carbon atoms, particularly 2 to 8 carbon atoms, such as propargyl, 3-pentynyl and the like), aryl groups (preferably having 6 to 30 carbon atoms, more preferably 6 to 20 carbon atoms, particularly 6 to 12 carbon atoms, such as phenyl, p-methylphenyl, naphthyl and the like), amino groups (preferably having 0 to 20 carbon atoms, more preferably 0 to 12 carbon atoms, particularly 0 to 6 carbon atoms, such as amino, methylamino, dimethylamino, dietylamino, diphenylamino, dibenzylamino and the like), alkoxy groups (preferably having 1 to 20 carbon atoms, more preferably 1 to 12 carbon atoms, particularly 1 to 8 carbon atoms, such as methoxy, ethoxy, butoxy and the like), aryloxy groups (preferably having 6 to 20 carbon atoms, more preferably 6 to 16 carbon atoms, particularly 6 to 12 carbon atoms, such as phenyloxy, 2-naphtyloxy and the like), acyl groups (preferably having 1 to 20 carbon atoms, more preferably 1 to 16 carbon atoms, particularly 1 to 12 carbon atoms, such as acetyl, benzoyl, formyl, pivaloyl and the like), alkoxycarbonyl groups (preferably having 2 to 20 carbon atoms, more preferably 2 to 16 carbon atoms, particularly 2 to 12 carbon atoms, such as methoxycarbonyl, ethoxycarbonyl and the like), aryloxycarbonyl groups (preferably having 7 to 20 carbon atoms, more preferably 7 to 16 carbon atoms, particularly 7 to 10 carbon atoms, such as phenyloxycarbonyl and the like), acyloxy groups (preferably having 2 to 20 carbon atoms, more preferably 2 to 16 carbon atoms, particularly 2 to 10 carbon atoms, such as acetoxy, benzoyloxy and the like), acylamino groups (preferably having 2 to 20 carbon atoms, more preferably 2 to 16 carbon atoms, particularly 2 to 10 carbon atoms, such as acetylamino, benzoylamino and the like), alkozycarbonylamino groups (preferably having 2 to 20 carbon atoms, more preferably 2 to 16 carbon atoms, particularly 2 to 12 carbon atoms, such as mathoxycarbonylamino and the like), aryloxycarbonylamino groups (preferably having 7 to 20 carbon atoms, more preferably 7 to 16 carbon atoms, particularly 7 to 12 carbon atoms, such as phenyloxycarbonyl amino and the like), sulfonylamino groups (preferably having 1 to 20 carbon atoms, more preferably 1 to 16 carbon atoms, particularly 1 to 12 carbon atoms, such as methanesulfonylamino, benzenesulfonylamino and the like), sulfamoyl groups (preferably having 0 to 20 carbon atoms, more preferably 0 to 16 carbon atoms, particularly 0 to 12 carbon atoms, such as sulfamoyl, methylsulfamoyl, dimethylsulfamoyl, phenylsulfamoyl and the like), carbamoyl groups (preferably having 1 to 20 carbon atoms, more preferably 1 to 16 carbon atoms, particularly 1 to 12 carbon atoms, such as carbamoyl, methylcarbamoyl, diethylcarbamoyl, phenylcarbamoyl and the like), alkylthio groups (preferably having 1 to 20 carbon atoms, more preferably 1 to 16 carbon atoms, particularly 1 to 12 carbon atoms, such as methylthio, ethylthio and the like), arylthio groups (preferably having 6 to 20 carbon atoms, more preferably 6 to 16 carbon atoms, particularly 6 to 12 carbon atoms, such as phenylthio and the like), sulfonyl groups (preferably having 1 to 20 carbon atoms, more preferably 1 to 16 carbon atoms, particularly 1 to 12 carbon atoms, such as mesyl, tosyl and the like), sulfinyl groups (preferably having 1 to 20 carbon atoms, more preferably 1 to 16 carbon atoms, particularly 1 to 0.12 ca on atoms, such as methanesulfinyl, benzenesulfinyl and the like9, ureido groups (preferably having 1 to 20 carbon atoms, more preferably 1 to 16 carbon atoms, particularly 1 to 12 carbon atoms, such as ureido, methylureido, phenylureido and the like), phosphoramide groups (preferably having 1 to 20 carbon atoms, more preferably 1 to 16 carbon atoms, particularly 1 to 12 carbon atoms, such as diethylphosphoramide, phenylphosphoramide and the like), hydroxy group, mercapto group, halogen atom (such as fluorine atom, chlorine atom, bromine atom, iodine atom), cyano group, sulfo group, carboxyl group, nitro group, hydroxam group, sulfino group, hydrazino group, imino group, heterocyclic group (preferably having 1 to 30 carbon atoms, more preferably 1 to 12 carbon atoms with heteroatoms such as nitrogen atoms, oxygen atoms and sulfur atoms, and typically, imidazolyl, pyridyl, quinolyl, furyl, thienyl, piperidyl, morpholino, benzoxazolyl, benzoimidazolyl, benzothiazolyl, carbazolyl, azepinyl and the like), silyl groups (preferably having 3 to 40 carbon atoms, more preferably 3 to 30 carbon atoms, particularly 3 to 24 carbon atoms, such as trimethylsilyl, triphenylsilyl and the like) and the like. Any of these substituents may further be substituted. When two or more substituents are present, they may be same or different. If possible, they may be taken together to form a ring.

A preferred amino acid derivative of the invention is a compound represented by Formula (2-A) and a compound represented by Formula (2-B) shown below.

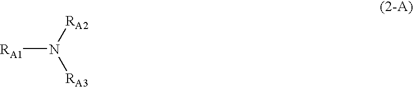

In this formula, R_{A1} is an alkyl group having 6 or more carbon atoms (preferably 6 to 40 carbon atoms), each of R_{A2} and R_{A3} is an alkyl group (preferably having 1 to 2 carbon atoms, more preferably 1 to 12 carbon atoms), a carboxyalkyl group (preferably having 1 to 4 carbon atoms) or a sulfoalkyl group (preferably having 1 to 4 carbon atoms), and at least one of R_{A2} and R_{A3} is a carboxyalkyl group or a sulfoalkyl group. The carboxyl group and the sulfo group in the carboxylalkyl group and the sulfoalkyl group may also be in the forms of respective salts (the same is applied analogously to the following R_{A5} and R_{A6}).

It is more preferable that R_{A1} is an alkyl group having 8 to 20 carbon atoms, and each of R_{2A} and R_{3A} is an alkyl group having 1 to 12 carbon atoms, a carboxyalkyl group having 1 to 4 carbon atoms.

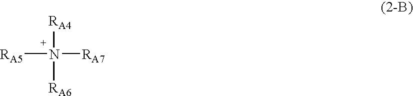

In this formula, R_{A4} is an alkyl group having 6 or more carbon atoms (preferably 6 to 40 carbon atoms), each of R_{A5} and R_{A6} is an alkyl group (preferably having 1 to 2 carbon atoms, more preferably 1 to 12 carbon atoms), a carboxyalkyl group (preferably having 1 to 4 carbon atoms) or a sulfoalkyl group (preferably having 1 to 4 carbon atoms), and R_{A7} is a COO⁻-containing alkyl group or a SO₃⁻-containing alkyl group.

It is more preferable that R_{A4} is an alkyl group having 8 to 20 carbon atoms, and each of R_{A5} and R_{A6} is an alkyl group having 1 to 12 carbon atoms, and R_{A7} is a COO⁻-containing alkyl group (preferably having 1 to 2 carbon atoms).

The preferred examples of the amino acid derivative of the invention are those listed below, to which the invention is not limited.

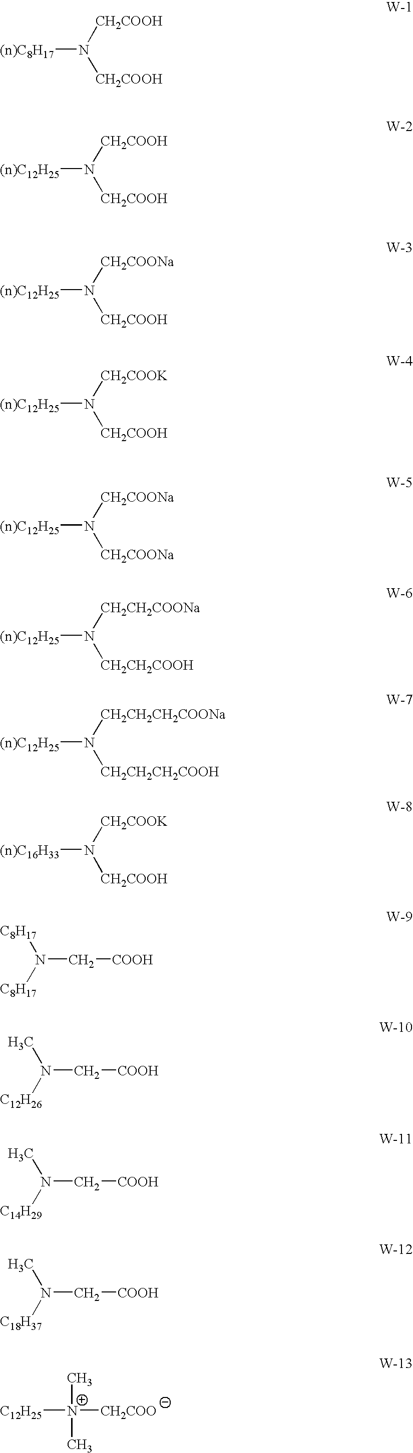

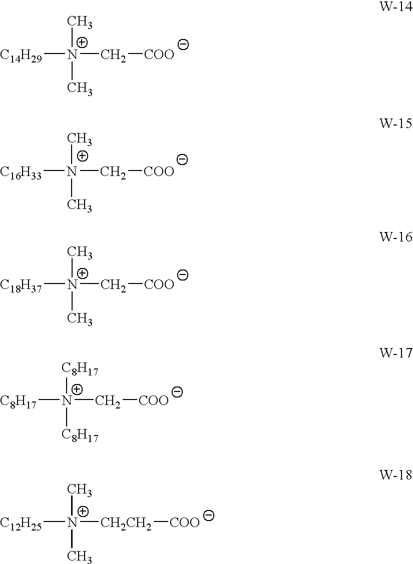

The metal chelating compound or the amino acid derivative of the invention is contained in an amount of 0.0001 to 10 g/m², preferably 0.001 to 5 g/l², specially 0.01 to 2 g/m² in an ink jet printing sheet. With regard to a layer to which those are added in the case of employing two coatings to be applied onto an ink jet printing sheet, it may be added to either layer, but those are added preferably to the top layer in view of the coating performance.

When the metal chelating compound or the amino acid derivative is contained in a colorant-receiving layer, it may be added in a mixture with a water-soluble organic solvent, such as an alcohol compound (methanol, ethanol, isopropyl alcohol, ethylene glycol, diethylene glycol, diethylene glycol monobutyl ether, polyethylene glycol, polypropylene glycol, glycerin, diglycerin, trimethylolpropane, trimethylolbutane and the like), an ether compound (tetrahydrofuran, dioxane and the like), an amide compound (dimethylformamide, dimethylacetoamide, N-methylpyrrolidone and the like), a ketone compound (acetone and the like) and the like, for increasing its affinity with water.

When the metal chelating compound or the amino acid derivative has no sufficient solubility in water, it may be added in a mixture with a hydrophobic organic solvent, such as an ester compound (ethyl acetate, dioctyl adipate, butyl phthalate, methyl stearate, tricresyl phosphate and the like), an ether compound (anisol, hydroxyethoxybenzene, hydroquinone dibutyl ether and the like), a hydrocarbon (toluene, xylene, diisopropylnaphthalene and the like), an amide compound (N-butylbenzenesulfonamide, stearic acid amide and the like), an alcohol compound (2-ethylhexyl alcohol, benzyl alcohol, phenethyl alcohol and the like), a ketone compound (hydroxyacetophenone, benzophenone, cyclohexane and the like) with or without a water-soluble organic solvent mixed thereto. When adding, any form such as an oil droplet, latex, solid dispersion, polymeric dispersion may be employed.

(Water-Soluble Resin)

In an ink jet printing sheet of the invention, a colorant-receiving layer preferably contains a water-soluble resin together with the metal chelating compound or the amino acid devivative.

Such a water-soluble resin may for example be a polyvinyl alcohol-based resin which is a resin having a hydroxy group as a hydrophilic structure unit [polyvinyl alcohol (PVA), acetoacetyl-modified polyvinyl alcohol, cation-modified polyvinyl alcohol, anion-modified polyvinyl alcohol, silanol-modified polyvinyl alcohol, polyvinyl acetal and the like] a cellulose-based resin [methyl cellulos (MC), ethyl cellulose (EC), hydroxyethyl cellulose (SEC), carboxymethyl cellulose (CMC), hydroxypropyl cellulose (HPC), hydroxyethylmethyl cellulose, hydroxypropylmethyl cellulose and the like], chitins, chitosans, starches, ether bond-carrying reins [polyoxyethylene oxide (PEO), polypropylene oxide (PPO), polyethylene glycol (PEG), polyvinyl ether (PVE) and the like], a carbamoyl group-carrying resin [polyacrylamide (PAAM), polyvinyl pyrrolidone (PVP), polyacrylic acid hydrazide and the like] and the like.

Those which may also be exemplified are polyacrylates having carboxyl groups as free groups, maleic acid resins, alginates, gelatins and the like.

Among those listed above, a polyvinyl alcohol-based resin is especially preferred. Such a polyvinyl alcohol may for example be those described in JP-B-4-52786, JP-B-5-67432, JP-B-7-29479, Japanese Patent No.2537827, JP-B-7-57553, Japanese Patent No.2502998, Japanese Patent No.3053231, JP-A-63-176173, Japanese Patent No.2604367, JP-A-7-276787, JP-A-9-207425, JP-A-11-58941, JP-A-2000-135858, JP-A-2001-205924, JP-A-2001-287444, JP-A-62-278080, JP-A-9-39373, Japanese Patent No.2750433, JP-A-2000-158801, Jr-A-2001-213045, JP-A-2001-328345, JP-A-8-324105, JP-A-11-348417 and the like.

Examples of the water-soluble resin other than the polyvinyl alcohol-based resin are the compounds listed in the description from the paragraph number [0011] to [0014] in JP-A-11-165461.

Any of these water-soluble resins may be employed alone or in combination with each other.

The amount of a water-soluble resin in the invention is preferably 9 to 40% by mass, more preferably 12 to 33% by mass based on the entire solid mass of a colorant-receiving layer.

(Microparticle)

In an ink jet printing sheet in the invention, it is further preferable that a colorant-receiving layer contains a water-soluble resin and a microparticle together with an inventive metal chelating compound or an inventive amino acid derivative.

The containment of a microparticle in a colorant-receiving layer results in a porous structure, which leads to an improved ink absorbing ability. Especially when the solid amount of said microparticle in the colorant-receiving layer is 50% by mass or more, preferably exceeds 60% by mass, a further satisfactory porous structure can be formed, resulting in a favorable ink jet printing sheet having a sufficient ink absorbing performance. A solid amount as used her in means a content calculated based on the constituents of the colorant-receiving layer other than water.

While a microparticle in the invention mentioned above may be an organic microparticle and inorganic microparticle, it is preferable to contain an inorganic microparticle in view of the ink absorption performance and the image stability.

An organic microparticle described above may for example be a polymeric microparticle obtained by an emulsion polymerization, microemulsion system polymerization, soap-free polymerization, seed polymerization; dispersion polymerization, suspension polymerization and the like, and is typically a powder of a polyethylene, polypropylene, polystyrene, polyacrylate, polyamide, silicon resin, phenol resin, naturally-occurring polymer and the like, as well as a polymeric microparticle in the form of a latex or emulsion.

An inorganic microparticle described above may for example be a silica microparticle, colloidal silica, titanium dioxide, barium sulfate, calcium silicate, zeolite, kaolinite, halloysite, mica, talc, calcium carbonate, magnesium carbonate, calcium sulfate, pseudo-boehmite, zinc oxide, zinc hydroxide, alumina microparticle, aluminum silicate, calcium silicate, magnesium silicate, zirconium oxide, zirconium hydroxide cerium oxide, lanthanum oxide, yttrium oxide and the like. Among those listed above, a silica microparticle, colloidal silica, alumina microparticle and pseudo-boehmite are preferred in view of an ability of producing a satisfactory porous structure. A microparticle may be employed as a primary particle or in a form of a secondary particle. The mean primary particle size of any of these microparticle is preferably 2 μm or less, more preferably 200 nm or less.

More preferably, a silica microparticle whose mean primary particle size is 20 nm or less, a colloidal silica whose mean primary particle size is 30 nm or less, an alumina microparticle whose mean primary particle size is 20 nm or less or a pseudo-boehmite whose mean pore radius is 2 to 15 nm are employed, with the silica microparticle, alumina microparticle and pseudo-boehmite being particularly preferred.

A silica microparticle is classified broadly to a wet process particle and a dry process (gas phase process) particle usually based on the production methods. Mostly in the wet process described above, a silicate is decomposed by an acid to form an activated silica, which is polymerized to an appropriate degree and allowed to aggregate and precipitate, whereby obtaining a hydrated silica. On the other hand, the gas phase process mainly employs a high temperature gas phase hydrolysis of a halogenated silica (flame hydrolysis) or a vaporization of a silica sand and a coke by heating and reducing using an arc in an electric furnace followed by an air oxidation (arc method), whereby obtaining an anhydrous silica, and the term “gas phase process silica” means an anhydrous silica microparticle obtained by this gas phase process. As a silica microparticle employed in the invention, a gas phase process silica is especially preferred.

A gas phase process silica described above is different from a hydrated silica in the surface silanol group density and the porosity, and thus exhibits different characteristics, and is suitable for forming a three dimensional structure of a high % void volume. Although the reasons for such different characteristics are not clear, it is assumed that a hydrated silica has a microparticle surface silanol group density as high as 5 to 8 groups/nm² which allows the silica microparticle to be aggregate readily with each other while a gas phase process silica has a microparticle surface silanol group density as low as 2 to 3 groups/nM² which leads to a occasional loose aggregation (flocculation), resulting in a structure having a high % void volume.

Since a gas phase process silica described above has an especially large specific surface area, it exhibits a high efficiency in absorbing and retaining an ink, and also since it has a low refractive index it can impart a receiving layer with a transparency if it is dispersed until achieving an appropriate particle size whereby giving a high color intensity and a satisfactory color development performance. The transparency of the receiving layer is important not only in the use which requires the transparency such as the use as an OHP sheet but also in the use as a printing sheet such as a photo-glossy paper which intends to obtain a high color intensity and a satisfactorily developed color gloss.

The mean primary particle size of any of a gas phase process silica described above is preferably 30 nm or less, more preferably 20 nm or less, particularly 10 nm or less, especially 3 to 10 nm. Since the gas phase process silica described above readily undergoes the adhesion between the particles via hydrogen bonds derived from the silanol groups, it can form a structure having a high % void volume when the mean primary particle size is 30 nm or less, whereby improving the ink absorption performance effectively.

A silica microparticle may be used in combination with other microparticles described above. When using a gas phase process silica in combination with such other microparticles, the gas phase process silica content in the total of the microparticles is preferably 30% by mass, more preferably 50% by mass.

An inorganic microparticle of the invention is preferably an alumina microparticle, alumina hydrate, mixtures or composite thereof. Among these, the alumina hydrate is preferable because it absorbs and fixes an ink satisfactorily, with a pseudo-boehmite (Al₂O₃.nH₂O) being particularly preferred. n is an integer of 1 to 8. While the alumina hydrate may be in any form, a sol boehmite is employed preferably as a starting material since it allows a smooth layer to be obtained easily.

With regard to the microporous structure of a pseudo-boehmite, the mean micropore radius is preferably. 1 to 30 nm, more preferably 2 to 15 nm. The micropore volume is preferably 0.3 to 2.0 ml/g, more preferably 0.5 to 1.5 ml/g.

The micropore radius and the micropore volume mentioned here are measured in accordance with a nitrogen adsorption/desorption method for example by using a gas adsorption/desorption analyzer (for example, a trade name *OMNISORP 369* manufactured by Coulter).

Among various alumina microparticles, a gas phase process alumina microparticle is preferable because of its large specific surface area. The mean primary particle size of said gas phase process alumina microparticle is preferably 30 nm or less, more preferably 20 nm or less.

When a microparticle is employed in an ink jet printing paper, it can be employed preferably also in the forms disclosed in JP-A-10-81064, JP-A-10-119423, JP-A-10-157277, JP-A-10-217601, JP-A-11-348409, JP-A-2001-138621, JP-A-2000-43401, JP-A-2000-211235, JP-A-2000-309157, JP-A-2001-96897, JP-A-2001-138627, JP-A-11-91242, JP-A-8-2087, JP-A-8-2090, JP-A-8-2091, JP-A-8-2093, JP-A-8-174992, JP-A-11-192777, JP-A-2001-301314 and the like.

Each of a water soluble resin and a microparticle described above which mainly constitute an inventive colorant-receiving layer may be a single material or may be a mixture of several materials. For the purpose of keeping the transparency, the type of the water-soluble resin combined with the microparticle, especially a silica microparticle, becomes important. When using a gas phase process silica described above, said water-soluble resin is preferably a polyvinyl alcohol-based resin, more preferably a polyvinyl alcohol-based resin having a saponification degree of 70 to 100%, especially a polyvinyl alcohol-based resin having a saponification degree of 80 to 99%.

A polyvinyl alcohol-based resin described above has a hydroxy group in its structural unit, and this hydroxy group and a surface silanol group of a silica microparticle described above form a hydrogen bond, whereby allowing a three dimensional network structure whose network chain unit is a secondary particle of the silica microparticle to be formed readily. As a result of the formation of this three dimensional network structure, a porous colorant-receiving layer having a high % void volume and a sufficient strength could be formed.

In an ink jet printing system, a colorant-receiving layer formed as described above absorbs an ink rapidly by a capillary phenomenon to form a dot of a satisfactory true circle without undergoing any ink blurring.

A polyvinyl alcohol-based resin may also be combined with other water-soluble resins described above. When using such other water-soluble resin in combination with the polyvinyl alcohol-based resin, the amount of the polyvinyl alcohol-based resin is preferably 50% by mass or more, more preferably 70% by mass or more based on the entire water-soluble resins.

<Ratio of Microparticle to Water-Soluble Resins>

The mass ratio of a microparticle (x) to water-soluble resins (y) [P/B/ratio (x/y)] exerts a significant effect on the film structure and the film strength of a colorant-receiving layer. Thus, a too high mass ratio [PB ratio] leads to an increase in the % void volume, the micropore volume and the surface area (per unit mass), but also leads to a reduction in the density and the strength.

A colorant-receiving layer of the invention preferably has a mass ratio [PB ratio (x/y)] described above within the range from 5:1 to 10:1, for the purpose of preventing the film strength reduction and the cracking upon drying due to a too high PB ratio while also preventing the ink absorbability reduction resulting from a reduced % void volume attributable to the tendency of clogging of a void with the resin due to a too low PB ratio.

When passing through the feeder system of an ink jet printer, a printing sheet may be subjected to a stress, and thus the color-receiving layer should have a sufficient film strength. Also for preventing any cracking or peeling of the color-receiving layer upon cutting into a sheet, the colorant-receiving layer should have a sufficient film strength. From this point of view, the mass ratio (z/y) described above is preferably 5:1 or lower and, while it is preferably 2:1 or higher for the purpose of ensuring the rapid ink absorbing ability in the ink jet printer.

For example, a gas phase process silica microparticle having a mean primary particle size of 20 nm or less and a water-soluble resin in a mass ratio (x/y) of 2:1 to 5:1 are dispersed thoroughly in an aqueous solution to form a coating solution, which is applied onto a support and dried to form a three dimensional network structure whose network chan is a secondary particle of the silica microparticle, whereby allowing a light transmissible porous film whose mean micropore size of 30 nm or less, % void volume of 50 to 80%, micropore specific volume of 0.5 ml/g or more and specific surface area of 100 m²/g or more to be produced easily.

(Crosslinking Agent)

The colorant-receiving layer in an ink jet printing sheet of the invention is preferably a porous layer in which a coating layer comprising a microparticle and a water-soluble resin further contain a crosslinking agent capable of crosslinking said water-soluble resin and which is cured as a result of the crosslinking reaction of said crosslinking agent with the water-soluble resin.

The crosslinking of a water-soluble resin described above, especially of a polyvinyl alcohol is conducted preferably using a boron compound. Such a boron compound may for example be a borax, boric acid, borate (for example, o-borate, InBO₃, ScBO₃, YBO₃, LaBO₃, Mg₃(BO₃)₂, CO₂(BO₃)₂, o-biborate (for example, Mg₂B₂O₅, CO₂BO₅), m-borate (for example, LBO₂, Ca (BO₂)₂, NO₂, KBO₂), tetraborate (for example, Na₂BO₇.10H₂O), pentaborate (for example, KB₅O₈.4H₂O, Ca₂B₆O₁₁.7₂O, CsB₅O₅) and the like. Among those listed above, those preferred are borax, boric acid and borate because of a rapid crosslinking reaction, with boric acid being especially preferred.

The crosslinking agent for a water-soluble resin described above may be one other than boron compounds and may be any of the following compounds. Examples include an aldehyde-based compound such as formaldehyde, glyoxal, glutaraldehyde and the like; a ketone-based compound such as diacetyl, cyclopentanedione and the like; an activated halide such as bis(2-chlorethylurea)-2-hydroxy-4,6-dichloro-1,3,5-triazine, 2,4-dichloro-6-S-triazine sodium salt and the like; an activated vinyl compound such as divinylsulfonic acid, 1,3-vinylsulfonyl-2-propanol, N,N′-ethylenebis(vinylsulfonylacetamide), 1,3,5-triacryloyl-hexabydro-S-triazine and the like; an N-methylol compound such as dimethylol urea, methylol dimethylhydantoin and the like; a melamine resin (for example, methylol melamine, alkylated methylol melamine); an epoxy resin; an isocyanate compound such as 1,6-hexamethylene diisocyanate and the like; aziridine compound described in U.S. Pat. No. 3,017,280 and 2983611; a carboxyimide compound described in U.S. Pat. No. 3,100,704; an epoxy-based compound such as glycelol triglycidyl ether and the like; an ethyleneimino-based compound such as 1,6-hexamethylene —N,N′-bisethyleneurea and the like; a halogenated carboxyaldehyde-based compound such as mucochloric acid, mucophenoxychloric acid and the like; a dioxan-based compound such as 2,3-dihydroxydioxane and the like; a metal-containing compound such as titanium lactate, aluminum sulfate, chromium alum, potassium alum, zirconyl acetate, chromium acetate and the like, a polyamine compound such as tetraethylene pentamine, a hydrazide compound such as adipic acid dihydrazide, a low molecular weight compound or polymer having two or more oxazoline group and the like.

Any of the crosslinking agents described above may be employed alone or in combination with each other.

A crosslinking agent described above is added as exemplified below using a boron compound. Thus, a colorant-receiving layer is a layer formed as a result of a crosslinking curing of a coating layer formed by applying a coating solution comprising at a microparticle, a water-soluble resin containing a polyvinyl alcohol and a crosslinking agent containing a boron compound (hereinafter sometimes referred to as a first coating solution), and the crosslinking curing is conducted by applying a basic solution whose pH is 8 or higher (hereinafter sometimes referred to as a second coating solution) onto said coating layer or a coating film (1) simultaneously with the application of said coating solution, or (2) during the course of the drying of the coating layer formed by applying said coating solution but before the time when said coating layer exhibits a reduced rate drying.

The amount of a crosslinking agent employed is preferably 1 to 50% by mass, more preferably 5 to 40% by mass based on a water-soluble resin.

(Mordant)

In the invention, it is preferred to add a mordant to a colorant-receiving layer in order to improve the water resistance of the image formed and the anti-blurring ability over a prolonged period.

Such a mordant is preferably a cationic polymer as an organic mordant (cationic mordant) or an inorganic mordant, and it undergoes, when contained in a colorant-receiving layer, an interaction with a liquid ink containing as a colorant an anionic dye, whereby stabilizing the colorant and improving the water resistance and the anti-blurring ability over a prolonged period. The organic and inorganic mordants may be employed alone independently or in combination with each other.

A mordant may be added to a coating solution containing a microparticle and a water-soluble resin (the first coating solution) or may be added to the second coating solution if it is suspected to form any aggregation with the microparticle.

A cationic mordant described above is preferably a polymeric mordant having a primary to tertiary amino group or a quaternary ammonium base as a cationic group, and a cationic non-polymeric mordant may also be employed.

Such a polymeric mordant is preferably a homopolymer of a monomer (mordant monomer) having a primary to tertiary amino group or a salt thereof, or a quaternary ammonium base, as well as a copolymer or a condensation polymer of such a mordant monomer with other monomers (hereinafter referred to as a non-mordant monomers). Such a polymeric mordant may be in the form either of a water-soluble polymer or a water-dispersible latex particle.

A monomer (mordant monomer) mentioned above may for example be trimethyl-p-vinylbenzylammonium chloride, trimethyl-m-vinylbenzylammonium chloride, triethyl-m-vinylbenzylammonium chloride, N N-dimethyl-N-ethyl-N-p-vinylbenzylammonium chloride, N,N-diethyl-N-mathyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinylbenzylammonium chloride, N,N-diethyl-N-benzyl-N-p-vinylbenzylammonium1 chloride, N,N-dimethyl-N-(4-methyl)benzyl-N-p-vinylbenzylammonium chloride, N,N-dimethyl-N-phenyl-N-p-vinylbenzylammonium chloride; trimethyl-p-vinylbenzylammonium bromide, trimethyl-m-yinylbenzylmmonium bromide, trimethyl-p-vinylbenzylammonium sulfonate, trimethyl-m-vinylbenzylammonium sulfonate, trimethyl-p-vinylbenzylammonium acetate, trimethyl-m-vinylbenzylammonium acetate, N,N,N-triethyl-N-2-(4-vinylphenyl)ethylammonium chloride, N,N,N-triethyl-N-2-(3-vinylphenyl) ethylammonium chloride, N,N-diethyl-N-methyl-N-2-(4-vinylphenyl)ethylamonium chloride, N,N-diethyl-N-methyl-N-2-(4-vinylphenyl)ethylammonium acetate; N,N-dimethylaminoethyl(meth)acrylate, N,N-diethylaminoethyl(meth)acrylate, N,N-dimethylaminopropyl(meth)acrylate, N,N-diethylaminopropyl(meth)acrylate, N,N-dimethylminoethyl(meth)acrylamide, N,N-diethylaminoethyl(meth)acrylamide, N,N-dimethylaminopropyl(meth)acrylamide, N,N-diethylaminopropyl(meth)acrylamide methyl chloride, ethyl chloride, methyl bromide, ethyl bromide, methyliodide or ethyliodide or ethyl iodide-derived quaternized substance or sulfonate, alkylnufonate, acetate or alkyl carboxylates thereof formed as a result of the substitution of its anion.

Those which may typically be exemplified are monomethyldiallylammonium chloride, trimethyl-2-(methacryloyloxy)ethylamonium chloride, triethyl-2-(methacryloyloxy)ethylammonium chloride, trimethyl-2-(acryloyloxy)ethylammonium chloride, triethyl-2-(acryloyloxy)ethylammonium chloride, trimethyl-3-(methacryloyloxy)propylammonium chloride, triethyl-3-(methacryloyloxy)propylammonium chloride, trimethyl-2-(methacryloylamino)ethylammonium chloride, triethyl-2-(methacryloylamino)ethylamonium chloride, triethyl-2-(acryloylamino)ethylammonium chloride, triethyl-2-(acryloylamino)ethylammonium chloride, trimethyl-3-(methacyloylamino)propylammonium chloride, trimethyl-3-(methacryloylamino)propylammonium chloride, trimethyl-3-(acryloylamino)propylammonium chloride, triethyl-3-(acryloylamino)propylammonium chloride, N,N-dimethyl-N-ethyl-2-(methacryloyloxy)ethylammonium chloride, N,N-diethyl-N-methyl-2-(methacryloyloxy)ethylammonium chloride, N,N-dimethyl-N-ethyl-3-(acryloylamino)propylammonium chloride, trimethyl-2-(methacryloyloxy)ethylammonium bromide, trimethyl-3-(acryloylamino)propylammonium bromide, trimethyl-2-(methacryloyloxy)ethylammonium sulfonate, trimethyl-3-(acryloylamino)propylammonium acetate and the like.

Otherwise, copolymerizable monomers such as N-vinylimidazole and N-vinyl-2-methylimidazole may also be exemplified.

It is also possible to use allylamine, diallylamine and derivatives or salts-thereof. Examples of such a compound include allylamine, allyamine hydrochloride, allylamin sulfate, diallylamine, diallylamine hydrochloride, diallylamine acetate, diallylamine sulfate, diallylmethylamine and its salt (for example, hydrochloride, acetate, sulfate and the like), diallylethylamine and its salt (for example, hydrochloride, acetate, sulfate and the like), diallyldimethylammonium salt (counteranion to which may for example be chloride, acetate ion and sulfate ion) and the like. Any of these allylamine and diallylamine derivatives is usually polymerized in the form of a salt because of its poor polymerizability in the form of an amine, and then desalted if necessary.

It is also possible to use N-vinylacetamide or N-vinylformamide units which are subsequently hydrolyzed to yield vinylamine units after polymerization, and salts of such units may also be employed.

A non-mordant monomer described above is a monomer which does not contain a basic or cationic moiety such as a primary to tertiary amino group or its salt, or quaternary ammonium base and which exhibits no or substantially slight interaction with a dye contained in the ink jet printing ink.

Such a non-mordant monomer may for example be alkyl (meth)actylates; cycloalkyl (meth)acrylates such as cyclohexyl (meth) acrylate; aryl (meth) acrylates such as phenyl (meth)acrylate; aralkyl esters such as benzyl (meth)acrylate; aromatic vinyls such as styren vinyltoluene and α-methylstyrene; vinyl esters such as vinyl acetate, vinyl propionate and vinyl versatate; allyl esters such as allyl acetate; halogen-containing monomers such as vinylidene chloride and vinyl chloride; olefins such as ethylene and propylene and the like.

Such an alkyl (meth)acrylate is preferably an alkyl (meth)acrylate whose number of the carbon atoms in its alkyl moiety is 1 to 18, such as methyl (meth)acrylate, ethyl (meth)acrylate, propyl (meth)acrylate, isopropyl (meth) acrylate, n-butyl (meth)acrylate, isobutyl (meth).acrylate, t-butyl (meth)acrylate, hexyl (meth)acrylate, octyl (meth)acrylate, 2-ethylhexyl (meth)acrylate, lauryl (meth)acrylate, stearyl (meth)acrylate and the like.

Among those listed above, methyl acrylate, ethylacrylate, methyl methacrylate, ethyl methacrylate and hydroxyethyl methacrylate are preferred.

Any of the non-mordant monomers listed above may be employed alone or in combination with each other.

A preferred polymeric mordant described above may also be polydiallyldimethylammonium chloride, polymethacryloyloxyethyl-β-hydroxyethyldimethylammonium chloride, polyethyleneimide, polyallylamine and its derivative, polyamide-polyamine resin, cationized starch, dicyanediamide formalin condensate, dimethyl-2-hydroxypropylammonium salt polymerization product, polyamidine, polyvinylamine, dicyanediamide-formalin polymeric condensate and other dicyane-based cationic resins, dicyaneamide-diethylenetriamine polymeric condensate and other polyamine-based cationic resins, epichlorohydrin-dimethylamine addition polymerization product, dimethyldiamineammonium chloride-SO₂ copolymerization product, diallylamine salt-SO₂ copolymerization product, (math)acrylate-containing polymer having in its ester moiety a quaternary ammonium base-substituted alkyl group, styryl polymer having a quaternary ammonium base-substituted alkyl group and the like.

Such a polymeric mordant may typically be those described in JP-A-48-28325, JP-A-54-74430, JP-A-54-124726, JP-A-55-22766, JP-A-55-142339, JP-A-60-23850, JP-A-60-23851, JP-A-60-23852, JP-A-60-23853, JP-A-60-57836, JP-A-60-60643, JP-A-60-118834, JP-A-60-122940, JP-A-60-122941, JP-A-60-122942, JP-A-60-235134, JP-A-1-161236, U.S. Pat. No. 2,484,430, U.S. Pat. No. 3,148,061, U.S. Pat. No. 3,309,690, U.S. Pat. No. 4,115,124, U.S. Pat. No. 4,124,386, U.S. Pat. No. 4,193,800, U.S. Pat. No. 4,273,853, U.S. Pat. No. 4,282,305, U.S. Pat. No. 4,450,224, JP-A-1-161236, JP-A-10-81064, JP-A-10-119423, JP-A-10-157277, JP-A-10-217601, JP-A-11-348409, JP-A-2001-138621, JP-A-2000-43401, JP-A-2000-211235, JP-A-2000-309157, JP-A-2001-96897, JP-A-2001-138627, JP-A-11-91242, JP-A-8-2087. JP-A-8-2090, JP-A-8-2091, JP-A-8-2093, JP-A-8-174992, JP-A-11-192777, JP-A-2001-301314, JP-B-5-35162, JP-B-5-35163, JP-B-5-35164, JP-B-5-88846, JP-A-7-118333, JP-A-2000-344990, Japanese Patent No. 2648847, Japanese Patent No. 2661677 and the like. Among those listed above, polyallylamines and its derivatives are especially preferred.

An organic mordant in the invention is preferably a polyallylamine and its derivative whose weight mean molecular weight is 100000 or less.

Nevertheless, in the invention, one containing 1% or less of low molecular weight components whose molecular weights are 500 or less is employed as a mordant. The molecular weight can be measured by a gel permeation chromatography (GPC).

A polyallylamine or its derivative in the invention may be any known allylamine polymer and its derivative. Such a derivative may for example be a salt of a polyallylamine with an acid (acid may for example be an inorganic acid such as hydrochloric acid, sulfuric acid, phosphoric acid and nitric acid, an organic acid such as methanesulfonic acid, toluenesulfonic acid, acetic acid, propionic acid, cinnamic acid, (meth)acrylic acid and the like, a combination thereof, or those in which a part of the allylamine is converted into a salt), a derivative of a polyallylamine obtained by a polymeric reaction, a copolymer of a polyallylamine with other copolymerizable momers (such monomers may for example be (meth)acrylates, styrenes, (meth) acrylamides, acrylonitrile, vinyl esters and the like).

Typically, the polyallylamine and its derivative may fcr example be the compounds described in JP-B-62-31722, JP-B-2-14364, JP-B-63-43402, JP-B-63-43403, JP-B-63-45721, JP-B-63-29881, JP-B-1-26362, JP-B-2-56365, JP-B-2-57084, JP-B-4-41686, JP-B-6-2780, JP-B-6-45649, JP-B-6-1S592, JP-B-4-68622, Japanese Patent No. 3199227, Japanese Patent No. 3008369, JP-A-10-330427, JP-A-11-21321, JP-A-2000-281728, JP-A-2001-106736, JP-A-62-256801, JP-A-7-173286, JP-A-7-213897, JP-A-9-235318, JP-A-9-302026, JP-A-11-21321, WO99/21901, WO99/19372, JP-A-5-140213, JP-W-11-506488 and the like.

It is also possible to employ an inorganic mordant as a mordant according to the invention, including a polyvalent water-soluble metal salt or a hydrophobic metal salt compound.

Typically, the inorganic mordant may for example be a salt or complex of a metal selected from the group consisting of magnesium, aluminum, calcium, scandium, titanium, vanadium, manganese, iron, nickel, copper, zinc, gallium, germanium, strontium, yttrium, zirconium, molybdenum, indium, barium, lanthanum, cerium, praseodymium, neodymium, samarium, europium, gadolinium, dysprosium, erbium, ytterbium, hafnium, tungsten and bismuth.

Those exemplified typically are calcium acetate, calcium chloride, calcium formate, calcium sulfate, barium acetate, barium sulfate, barium phosphate, manganese chloride, manganese acetate, manganese formate dihydrate, ammonium manganese sulfate hexahydrate, cupric chloride, copper (II) ammonium chloride dihydrate, copper sulfate, cobalt chloride, cobalt thiocyanate, cobalt sulfate, nickel sulfate hexahydrate, nickel chloride hexahydrate, nickel acetate tetrahydrate, ammonium nickel sulfate hexahydrate, nickel amidosulfate tetrahydrate, aluminum sulfate, aluminum alum, basic polyaluminium hydroxide, aluminum sulfite, aluminum thiosulfate, polyaluminium chloride, aluminum nitrate nonahydrate, aluminum chloride hexahydrate, ferrous bromide, ferrous chloride, ferric chloride, ferrous sulfate, ferric sulfate, zinc phenolsulfonate, zinc bromide, zinc chloride, zinc nitrate hexahydrate, zinc sulfate, titanium tetrachloride, tetraisopropyl titanate, titanium acetylacetonate, titanium lactate, zirconium acetylacetonate, zirconyl acetate, zirconium sulfate, ammonium zirconium carbonate, zirconyl stearate, zirconyl actylate, zirconyl nitrate, zirconium oxychloride, zirconium hydroxychloride, chromium acetate, chromium sulfate, magnesium chloride hexahydrate, magnesium citrate nonahydrate, sodium phosphorus tungstate, tungsten sodium citrate, 12 tungatophosphoric acid n-hydrate, 12 tungstosilicic acid 26-hydrate, molybdenum chloride, 12 molybdopshophoric acid n-hydrate, gallium nitrate, germanium nitrate, strontium nitrate, yttrium acetate, yttrium chloride, yttrium nitrate, indium nitrate, lanthanum benzoate, cerium chloride, cerium sulfate, cerium octylate, praseodymium nitrate, neodymium nitrate, samarium nitrate, europium nitrate, gadolinium nitrate, dysprosium nitrate, erbium nitrate, ytterbium nitrate, hafnium nitrate, bismuth nitrate and the like.

An inorganic mordant of the invention is preferably an aluminum-containing compound, titanium-containing compound, zirconium-containing compound, a compound of a metal in the series of Group IIB in the periodic table (salt or complex).

A mordant content in an inventive colorant-receiving layer is preferably 0.01 g/m² to 5 g/m², more preferably 0.1 g/m² to 3 g/m².

(Other Components)

An ink jet printing sheet of the invention may contain various known additives if necessary, including acids, UV absorbing agents, antioxidants, fluorescent whitening agents, monomers, initiators, inhibitors, anti-blurring agents, preservatives, viscosity stabilizers, antifoam agents, surfactants, antistatics, matt agents, anti-curling agents, water resistance-imparting agents and the like.

A colorant-receiving layer in the invention may contain an acid. By adding such an acid, the surface pH of the colorant-receiving layer is adjusted at 3 to 8, preferably 5 to 7.5. As a result, the anti-yellowing ability of the blank area is favorably improved. The measurement of the surface pH is conducted by Method A (application method) of the Surface pH Measurements prescribed by J.TAPP (Japanese Paper Pulp Technology Association). Such a measurement can be conducted for example by using a paper surface pH measuring set “Model MPC” manufactured by KYORITSU RIKAGAKU KENKYUSHO (KK) corresponding to Method A described above.

Typical examples of the acids are formic acid, acetic acid, glycolic acid, oxalic acid, propionic acid, malonic acid, succinic acid, adipic acid, maleic acid, malic acid, tartaric acid, citric acid, benzoic acid, phthalic acid, isophthalic acid, glutaric acid, gluconic acid, lactic acid, aspartic acid, glutamic acid, salicylic acid, salicylic acid metal salt (salt of Zn, Al, Ca, Mg and the like), methanesulfonic acid, itaconic acid, benzenesulfonic acid, toluenesulfonic acid, trifluoromethanesulfonic acid, styl nesulfonic acid, trifluoroacetic acid, barbituric acid, acrylic acid, methacrylic acid, cinnamic acid, 4-hydrozybenzoic acid, aminobenzoic acid, naphthalenedisulfonic acid, hydroxybenzenesulfonic acid, toluenesulfinic acid, sulfanilic acid, sulfaminic acid, α-resorcinic acid, β-resorcinic acid, γ-resorcinic acid, gallic acid, phloroglucin, sulfosalicylic acid, ascorbic acid, erythorbic acid, bisphenolic acid, hydrochloric acid, nitric acid, sulfuric acid, phosphoric acid, polyphosphoric acid, boric acid, boronic acid and the like. The amount of such an acid may be determined so that the surface pH of the colorant-receiving layer becomes 3 to 8.

An acid described above may be employed in the form of a metal salt (for example, a salt of sodium, potassium, calcium, cesium, zinc, copper, iron, aluminum, zirconium, lanthanum, yttrium, magnesium, strontium, cerium and the like), or an amine salt (for example, ammonia, triethylamine, tributylamine, piperazine, 2-methylpiperazine, polyallylamine and the like).

In the invention, a colorant-receiving layer preferably contain storage stability-improving agents such as UV absorbers, antioxidants, anti-blurring agents and the like.

Such UV absorbers, antioxidants or anti-blurring agents may for example be alkylated phenol compounds (including a hindered phenol compounds), alkylthiomethylphenol compounds, hydroquinone compounds, alkylated hydroquinone compounds, toc pherol compounds, tiodiphenyl ether compounds, two or more thioether bond-carrying compounds, bisphenol compounds, O—, N— and S-benzyl compounds, hydrpxybenzyl compounds, triazine compounds, phosphonate compounds, acylaminophenol compounds, ester compounds, amide compounds, ascorbic acid, amine-based antioxidants, 2-(2-hydroxyphenyl)benzotriazole compounds, 2-hydroxybenzophenone compounds, acrylates, water-soluble or hydrophobic metal salts, organic metal compounds, metal complexes, hindered amine compounds (including TEMPO compounds), 2-(2-hydroxyphenyl)-1,3,5-triazine compounds, metal inactivator compounds, phosfite compounds, phosphonite compounds, hydrozyamine compounds, nitroso compounds, peroxide scavengers, polyamide stabilizers, polyether compounds, basic auxiliary stabilizers, nucleating agent, benzofuranone compounds, indolinone compounds, phosphine compounds, polyamine compounds, thiourea compounds, urea compounds, hydrazide compounds, amidine compounds, saccharide compounds, hydroxybenzoic acid compounds, dihydroxybenzoic acid compounds, trihyroxybenzoic acid compounds and the like.

Among those listed above, those employed preferably are alkylated phenol compounds, two or more thioether bond-carrying compounds, bisphenol compounds, ascorbic acid, amine-based antioxidants, water-soluble or hydrophobic metal salts, organic metal compounds, metal complex s, hindered amine compounds, hydroxyane compounds, polyamine compounds, thiourea compounds, hydrazide compounds, hydroxybenzoic acid compounds, dihydroxybenzoic acid compounds, trihydroxybenzoic acid compounds and the like.

Compounds exemplified typically are those described in Japanese Patent Application No.2002-13005, JP-A-10-182621, JP-A-2001-260519, JP-B-4-34953, JP-B-4-34513, JP-A-11-170686, JP-B-4-34512, EP1138509, JP-A-60-67190, JP-A-7-276808, JP-A-2001-94829, JP-A-47-10537, JP-A-58-111942, JP-A-58-212844, JP-A-59-19945, JP-A-59-46646, JP-A-59-109055, JP-A-63-53544, JP-B-36-10466, JP-B-42-26187, JP-B-48-30492, JP-B-48-31255, JP-B-48-41572, JP-B-48-54965, JP-B-50-10726, U.S. Pat. No. 2,179,086, U.S. Pat. No. 3,707,375, U.S. Pat. No. 3,754,919, U.S. Pat. No. 4,220,711, JP-B-45-4699, JP-B-54-5324, EP-A-223739, EP-A-309401, EP-A-309402, EP-A-310551, EP-A-310552, EP-A-459416, Germany Patent Application No.3435443, JP-A-53-48535, JP-A-60-107384, JP-A-60-107383, JP-A-60-125470, JP-A-60-125471, JP-A-60-125472, JP-A-60-287485, JP-A-60-287486, JP-A-60-287487, JP-A-60-287488, JP-A-61-160287, JP-A-6′-185483, JP-A-61-211079, JP-A-62-146678, JP-A-62-146680, JP-A-62-146679, JP-A-62-282885, JP-A-62-262047, JP-A-63-051174, JP-A-63-89877, JP-A-63-88380, JP-A-66-88381, JP-A-63-113536, JP-A-63-163351, JP-A-63-203372, JP-A-63-224989, JP-A-63-251282, JP-A-63-267594, JP-A-63-182484, JP-A-1-239282, JP-A-2-262654, JP-A-2-71262, JP-A-3-121449, JP-A-4-29169S, JP-A-4-291684, JP-A-5-61166, JP-A-5-119449, JP-A-5-188687, JP-A-5-188686, JP-A-5-110490, JP-A-5-1108437, JP-A-5-170361, JP-B-48-43295, JP-B-48-33232, U.S. Pat. No. 4,814,262, U.S. Pat. No. 4,900,275 and the like.

Any of other components mentioned above may be employed alone or in combination with each other. Any of these other components mentioned above may be added after being solubilized in water, dispersed, polymer-dispersed, emulsified, converted into oil droplets, or may be encapsulated in microcapsules. In an ink jet printing sheet of the invention, the amount of such other components mentioned above to be added is preferably 0.01 o 10 g/m².

Also for the purpose of improving the dispersibility of an inorganic microparticle, the inorganic surface is treated with a silane coupling agent. Such a silane coupling agent is preferably one having an organic functional group (for example, vinyl group, amino group (primary to tertiary amino group, quaternary ammonium base), epoxy group, mercapto group, chloro group, alkyl group, phenyl group, ester group and the like) in addition to the moiety serving for the coupling treatment.

In the invention, a colorant-receiving layer preferably contain a surfactant. Such a surfactant may be any of cationic, anionic, nonionic, amphoteric, fluorine-based, silicon-based surfactants.

A nonionic surfactant mentioned above may for example be polyoxyalkylene alkyl ether and polyoxyalkylene phenyl ethers (for example, diethyleneglycol monoethyl ether, diethyleneglycol diethyl ether, polyoxyethylene lauryl ether, polyoxyethylene stearyl ether, polyoxyethylene nonyl ether and the like), oxyethylene oxypropylene block copolymer, sorbitan fatty acid eaters (for example, sorbitan monolaurate, sorbitan monooleate, sorbitan trioleate and the like), polyoxyethylene sorbitan fatty acid esters (for example, polyoxyethylene sorbitan monolaurate, polyoxyethylene sorbitan monooleate, polyoxyethylene sorbitan trioleate and the like), polyoxyethylene sorbitol fatty acid esters (for example, tetraoleic acid polyoxyethylene sorbit and the like), glycerin fatty acid esters (for example, glycerol monooleate and the like), polyoxyethylene glycerin fatty acid esters (monostearic acid polyoxyethylene glycerin, monooleic acid polyoxyethylene glycerin and the like), polyethylene fatty acid esters (polyethyleneglycol monolaurate, polyethyleneglycol monooleate and the like), polyoxyethylene alkylamine, acetyleneglycols (for example, 2,4,7,9-tetramethyl-5-decyn-4,7-diol, and ethyleneoxide adduct, propyleneoxide adduct of said diol and the like) and the like, with polyozyalkylene alkyl ethers being preferred. Such a nonionic surfactant may be used in a first coating solution and a second coating solution. Any of the nonionic surfactants listed above may be employed alone or in combination with each other.

An amphoteric surfactant mentioned above may for example be of an amino acid type, carboxyammonium betaine type, sulfone ammonium betaine type, ammonium sulfate betaine type, imidazolium betaine type and the like, and those described in U.S. Pat. No. 3,843,368, JP-A-59-49535, JP-A-63-236546, JP-A-5-303205, JP-A-8-262742, JP-A-10-282619, Japanese Patent No. 2514194, Japanese Patent No. 2759795, JP-A-2000-351269 can preferably be employed. Among the amphoteric surfactants listed above, those of amino acid type, carboxyammonium betaine type and sulfone ammonium betaine type are preferred. Any of the amphoteric surfactants listed above may be employed alone or in combination with each other.

An anionic surfactant mentioned above may for example be a fatty acid salt (for example, sodium stearate, potassium oleate), an alkyl sulfate (for example, sodium laurl sulfate, triethanolamine lauryl sulfate), a sulfonate (for example, sodium dodecylbenzene sulfonate), an alkylsulfosuccinate (for example, sodium dioctylsulfosuccinate), an alkyldiphenyl ether disulfonate, an alkylphosphate and the like.

A cationic surfactant mentioned above may for example be an alkylamine salt, quaternary ammonium salt, pyridinium salt, imidazolium salt and the like.

A fluorine-based surfactant may for example be a compound obtained by derivatizing via a perfluoroalkyl group-carrying intermediate using a electrolytic fluorination, telomerization, oligomerization and the like.

Those which an be exemplified are perfluoroalkyl sulfonates, perfluoroalkyl carboxylates, perfluoroalkyl ethylene oxide adducts, perfluoroalkyl trialkylammoniun salts, perfluoroalkyl group-carrying oligomers, perfluoroalkyl phosphates and the like.

A silicon-based surfactant described above is preferably a silicon oil modified with an organic group, and may be in a structure in which the side chain of a siloxane backbone is modified with an organic group, in which the both terminals are modified or in which one terminal is modified. Such an organic group modification may be an amino modification, polyether modification, epoxy modification, carboxyl modification, carbinol modification, alkyl modification, aralkyl modification, phenol modification, fluorine modification and the like.

The surfactant content according to the invention is preferably 0.001 to 2.0%, more preferably 0.01 to 1.0% based on the coating solution for a colorant-receiving layer. When using two or more solution as the coating solutions for a colorant-receiving layer, it is preferable to add a surfactant to each solution.

In the invention, a colorant-receiving layer preferably contains an organic solvent having a high boiling point for preventing curls. Such an organic solvent having a high boiling point is an organic compound whose boiling point is 150° C. or higher under atmospheric pressure and is a water-soluble and hydrophobic compound. Such compound may be solid or liquid at room temperature, and may have a low or high molecular weight.

Those which can typically be exemplified are aromatic carboxylates (for example dibutyl phthalate, diphenyl phthalate, phenyl benzoate and the like), aliphatic carboxylates (for example, dioctyl adipate, dibutyl sebacate, methyl stearate, dibutyl maleate, dibutyl fumarate, triechyl acetylcitrate and the like), phosphates (for example, trioctyl phosphate, tricresyl phosphate and the like), epoxy compounds (for example, epoxy-derivatized soybean oil, epoxy-derivatized fatty acid methyl ester and the like), alcohols (for example, stearyl alcohol, ethylene glycol, propylene glycol, diethylene glycol, triethylene gLycol, glycerin, diethylene glycol monobutyl ether (DEGMBE), triethylene glycol monobutyl ether, glycerin momethyl ether, 1,2,3-butanetriol, 1,2,4-butanetriol, 1,2,4-pentanetriol, 1,2,6-hexanetriol, thiodiglycol, triethanolamine, polyethylene glycol and the like), vegetable oils (for example, soybean oil, sunflower oil and the like), higher aliphatic carboxylic acids (for example, linolic acid, oleic acid and the like) and the like.

(Support)

A support employed in the invention may be a transparent support made from a transparent material such as a plastic, or a non-transparent support made from a non-transparent material such as a paper. For the purpose of taking advantage of the transparency of a colorant-receiving layer, it is preferable to use a transparent support or a highly glossy non-transparent support.

A material which can be used as a transparent support described above is preferably a material which is transparent and durable against a radiant heat exerted upon OHP or backlight displaying. Such a material may include polyesters such as a polyethylene terephthalate (PET); polysulfones, polyphenylene oxides, polyimides, polycarbonates, polyamides and the like. Among those listed above, polyesters are employed preferably, with a polyethylene terephthalate being preferred especially.

The thickness of a transparent support mentioned above is not limited particularly, and is preferably 50 to 200 μm for the purpose of easy handling.

A highly glossy non-transparent support is preferably one whose gloss degree of the surface on the side provided with a colorant-receiving layer is 40% or higher. Such a gloss degree is a value obtained in accordance with the method prescribed in JIS P-8142 (75-degree mirror surface gloss test of paper and sheet). Typically, the following supports are contemplated.

Such a support may for example be a highly glossy paper support such as an art paper, coat paper, cast-coat paper and baryta paper employed for example as a silver halide photograph support; a highly glossy film obtained by adding a white pigment and the like to a plastic film of a polyester such as a polyethylene terephthalate (PET), cellulose esters such as nitrocellulose, cellulose acetate, cellulose acetate butyrate and the like, polysulfone, polyphenylene oxide, polyimide, polycarbonate, polyamide and the like, to make said film opaque (with or without calendering); or a support having a coating layer of a polyolefin which may or may not contain a white pigment over the surface of any of the above-mentioned various paper supports, transparent supports or white pigment-containing highly glossy films.

A white pigment-containing foamed polyester (for example, a foamed PET obtained by adding a polyolefin microparticle and extending to form voids) is also exemplified preferably. Furthermore, a resin coated paper employed in a photographic paper for a silver halide photograph is also contemplated.

While the thickness of a non-transparent support is not limited particularly, it is preferably 50 to 300 μm for the purpose of easy handling.

The surface of a support described above may be subjected to a corona discharge treatment, glow discharge treatment, flame treatment, ultraviolet light irradiation treatment and the like, for the purpose of improving the wettability and the adhesiveness.

A original paper employed in a resin coated paper described above is discussed below.

Such a original paper is made using as a main starting material a wood pulp which is combined if necessary with a synthetic pulp such as a polypropylene, or synthetic fiber such as a nylon or polyester. Such a wood pulp may for example be LBKP, LBSP, NBKP, NBSP, LDP, NDP, LUKP, NUKP, and it is preferable to use a larger amount of LBKP, NBSP, LBSP, NDP and LDP each of which contains a larger amount of short fibers.

Nevertheless, the ratio of LBSP and/or LDB is 10% by mass or higher and 70% by mass or lower.

A pulp mentioned above is preferably a chemical pulp (sulfate pulp or sulfite pulp) having a reduced amount of impurities, and a pulp whose whiteness is improved by bleating is also useful.

A original paper may contain, if necessary, a sizing agent such as a higher fatty acid, alkylketene dimer and the like, a white pigment such as calcium carbonate, talc, titanium oxide and the like, a reinforcing agent such as a starch, polyacrylamide, polyvinyl alcohol and the like, a fluorescent whitening agent, a humectant such as polyethylene glycol, a dispersing agent, a softening agent such as a quaternary ammonium and the like.

A drainage degree of a pulp used for making a paper is 200 to 500 ml under the prescription of CSF, and the fiber length after refining is preferably such a length that the sum of the % by mass of the 24 mesh residue and the % by mass of the 42 mesh residue becomes 30 to 70%. The % by mass of the 4 mesh residue is preferably 20% by mass or less.

The unit weight of a original paper is preferably 30 to 250 g, especially 50 to 200 g per 3.3 m³. The thickness of the original paper is preferably 40 to 250 μm. The original paper may be imparted with a high smoothness by subjecting to a calendering during or after the papermaking process. The density of the original paper is usually 0.7 to 1.2 g/m² (JIS P-8118).

The rigidity of the original paper is preferably 20 to 200 g under the condition prescribed in JIS P-8143.

On the surface of a original paper, a surface sizing agent may be applied, and such a surface sizing agent may be similar to that to be added to the original paper described above.

The pH of a original paper is preferably 5 to 9 when measured by the hot water extraction method prescribed in JIS P-8113.

A polyethylene coated on the front and back surfaces of a original paper is mainly a low density polyethylene (LDPE) and/or a high density polyethylene (HDPE), and, other polyethylene such as LLDPE or polypropylene may also be employed partly.

The polyethylene layer especially on the side where a colorant-receiving layer is formed is preferably supplemented with a titanium oxide of a rutile or anatase type, fluorescent whitening agent, ultramarine blue, whereby improving the non-transparency, whiteness and hue. The titanium oxide content is preferably about 3 to 20% by mass, more preferably 4 to 13% by mass based on the polyethylene. While the thickness of the polyethylene layer is not limited particularly, it is preferably 10 to 5 μm on the both side. It is also possible to provide a primer layer on the polyethylene layer to ensure a close adhesion to the colorant-receiving layer. Such a primer layer is preferably of an aqueous polyester, gelatin and PVA. The thickness of the primer layer is preferably 0.01 to 5 μm.

A polyethylene-coated paper can be used as a glossy paper, or may be imparted with a matt surface or silky surface such as one employed in an ordinary photographic paper by conducting an embossing treatment upon extruding a polyethylene over the surface of a original paper to effect coating.

A support may be provided also with a back coat layer, and this back coat layer can be supplemented with a white pigment, aqueous binder and other components.

A white pigment to be incorporated into a back coat layer may for example be a white inorganic pigment such as a light precipitated calcium carbonate, heavy precipitated calcium carbonate, kaolin, talc, calcium sulfate, barium sulfate, titanium dioxide, zinc oxide, zinc sulfide, zinc carbonate, satin white, aluminum silicate, kieselguhr, calcium silicate, magnesium silicate, synthetic amorphous silica, colloidal silica, colloidal alumina, pseudo-boehmite, aluminum hydroxide, alumina, lithopone, zeolite, hydrated halloysite, magnesium carbonate, magnesium hydroxide and the like, as well as an organic pigment such as styrene-based plastic pigment, acryl-based plastic pigment, polyethylene, microcapsule, urea resin, melamine resin and the like.

An aqueous binder employed in a back coat may for example be an aqueous polymer such as a styrene/maleate copolymer, styrene/acrylate copolymer, polyvinyl alcohol, silanol-modified polyvinyl alcohol, starch, cationized starch, casein, gelatin, carboxymethyl cellulose, hydroxyethyl cellulose, polyvinyl pyrrolidone and the like, as well as a water-dispersible polymer such as styrene butadiene latex, acryl emulsion and the like.

Other component contained in a back coat layer may for example be antifoam agents, foaming inhibitor, dye, fluorescent whitening agent, preservative, water resistance-imparting agent and the like.

Preparation of Ink Jet Printing Sheet

A colorant-receiving layer in an inventive ink jet printing sheet is formed preferably by a method (Wet-on-Wet method) in which a first coating solution containing at least a microparticle and a water-soluble resin (preferably together with a crosslinking agent) (hereinafter sometimes referred to as “Coating solution (A)” is applied onto the surface of a support, and then, either (1) simultaneously with said application, or (2) during the course of the drying of the coating layer formed by said application but before the time when said coating layer exhibits a reduced rate drying velocity, a second coating solution containing at least a mordant at a pH of 8 or higher (hereinafter sometimes referred to as “Coating Solution (B)”, and then the coating layer (or coating film) thus coated with the second coating solution is cured by crosslinking.

To provide a colorant-receiving layer thus cured by crosslinking is preferable from the viewpoint of ink absorption and film crack prevention.

Since the procedure discussed above serves to allow a mordant to be present densely near the surface of a colorant-receiving layer, a sufficient mordancy of the colorant of the ink jet printing ink, resulting in a favorable improvement in the water resistance of printed letters and images. A part of the mordant may be contained in Coating Solution (A), and in such a case the mordant in Coating Solution (A) may be similar to that in Coating Solution (B).

In the invention, a coating solution for a colorant-receiving layer (Coating Solution (A)) containing at least a microparticle (for example a gas phase process silica) and a water-soluble resin (for example, polyvinyl alcohol) can be prepared for example by the procedure described below. Thus, the gas phase process silica microparticle is added to water (for example in an amount of 10 to 20% by mass of the silica microparticle in water), and dispersed using a high speed rotation colloid mill (for example, *CLEARMIX* manufacture by M TECHNIC) operated at a speed as high as 10000 rpm (preferably 5000 to 20000 rpm for example over a period of 20 minutes (preferably 10 to 30 minutes), and then combined with a crosslinking agent (boron compound), aqueous solution of polyvinyl alcohol (PVA) (for example PVA corresponding to about 1/3 of the mass of the gas phase process silica described above), further combined with a metal chelating compound or an amino acid derivative of the invention, and then dispersed under the rotation condition similar to that described above. The resultant coating solution is an uniform sol, which is applied onto a support by an application method described above and then dried, whereby forming a porous colorant-receiving layer having a three dimensional network structure.

The preparation of an aqueous dispersion consisting of a gas phase process silica described above and a dispersant may be conducted by first preparing an aqueous dispersion of the gas phase process silica followed by adding said aqueons dispersion to the aqueous solution of a dispersant, or by adding an aqueous solution of the dispersant to the aqueous dispersion of the gas phase process silica, or by mixing altogether at once. The gas phase process silica in a form of a powder instead of its aqueous dispersion may be added to an aqueous solution of the dispersant as described above.

After mixing the gas phase process silica and the dispersant described above, the mixture is subjected to a dispersing machine to convert into finer particles, whereby obtaining an aqueous dispersion whose mean particle size is 50 to 300 nm. The dispersing machine used for obtaining such an aqueous dispersion may by any of various known dispersing machines such as a high speed rotation dispersing machine, medium agitation dispersing machine (ball mill, sand mill and the like), ultrasonic dispersing machine, colloid mill dispersing machine, high pressure dispersing machine and the like, and an agitation dispersing machine, colloid mill dispersing machine or high pressure dispersing machine is preferred because of an ability of dispersing a microparticle chunk formed efficiently.

As a solvent in each step, water, an organic acid or a mixture thereof can be employed. An organic solvent employed in the application step includes alcohols such as methanol, ethanol, n-propanol, i-propanol, methoxypropanol and the like, ketones such as acetone, methyl ethyl ketone and the like, tetrahydrofuran, acetonitrile, ethyl acetate, toluene and the like.

As a dispersant described above, a cationic polymer can be employed. Such a cationic polymer may for example be one exemplified for the mordant described above. It is also preferable to use a silane coupling agent as a dispersant.

The amount of a dispersant described above is preferably 0.1% to 30%, more preferably 1 to 10% based on a microparticle.

The application of a coating solution for a colorant-receiving layer can be conducted by a known application method using an extrusion dye coater, air doctor coater, blade coater, rod coater, knife coater, squeeze coater, reverse roll coater, bar coater and the like.

Simultaneously with or after the application of a coating solution for a colorant-receiving layer (Coating Solution (A)), said coating layer is coated with Coating Solution (B), which may be applied also before the time when said coating layer exhibits a reduced rate drying velocity. Thus, after applying the colorant-receiving layer (Coating Solution (A)) and during the time period in which this coating layer exhibits a constant rate drying velocity, a mordant is introduced, whereby effecting a preferable production.

As used herein, the expression “before the time when a coating layer exhibits a reduced rate drying” means a process for a several minutes immediately after the application of a coating solution for a colorant-receiving layer, during which the solvent (dispersion medium) content in the coating layer already applied is reduced in proportion with the time period, thus exhibiting the phenomenon of the “constant rate drying velocity”. The time period during which the “constant rate drying velocity” is exhibited is described for example in “KAGAKU KOGAKU BINRAN” (p.707 to 712, Published by MARUZEN, Oct. 25, 1980).

As described above, the application of a first coating solution is followed by drying until the time when said coating layer exhibits a reduced rate drying velocity, and this drying is conducted usually at 50 to 180° C. for a period of 0.5 to 10 minutes (preferably 0.5 to 5 minutes). While it is a matter of course that the drying time may vary depending on the amount of the coating, the range specified above is usually appropriate.

A method for the application before the time when the first coating layer exhibits a reduced rate drying velocity may for example be (1) a method in which Coating Solution (B) is applied further on the coating layer, (2) a method employing a spraying step, and (3) a method in which a support having said coating layer formed thereon is immersed in Coating Solution (B).

In the method (1) described above, Coating Solution (B) is applied utilizing a known application method for example by using a curtain flow coater, extrusion dye coater, air doctor coater, blade coater, rod coater, knife coater, squeeze coater, reverse roll coater, bar coater and the like. Nevertheless, it is preferable to utilize a method avoiding any direct contact of the coater with an already formed first coating layer, such as those employing an extrusion dye coater, curtain flow coater, bar coater and the like.

After the application of said mordant solution (Coating Solution (B)), the drying and the curing are effected by heating usually at 40 to 180° C. for a period of 0.5 to 30 minutes. It is preferred to heat at 40 to 150° C. for 1 to 20 minutes.

When a mordant solution (Coating Solution (B)) is applied simultaneously with a coating solution for a colorant-receiving layer (Coating Solution (A)), the coating solution for a colorant-receiving layer (Coating Solution (A)) and the mordant solution (Coating Solution (B)) are applied (as a multilayer coating) onto a support with the coating solution for a colorant-receiving layer (Coating Solution (A)) being brought into contact with the support, and then dried and cured, whereby forming a colorant-receiving layer.

The simultaneous application (multilayer coating) can be conducted by an application method using an extrusion die coater and curtain flow coater. After the simultaneous application, the coating layer thus formed is dried usually by heating the coating layer at 40 to 150° C. for 0.5 to 10 minutes, preferably at 40 to 100° C. for 0.5 to 5 minutes.

When the simultaneous application (multilayer coating) described above is conducted for example by using an extrusion die coater, the two coating solution extruded simultaneously are laminated near the die of the extrusion die coater, i.e., just before being transferred onto a support, and then kept in this condition while being applied as a multilayer coating over the support. Since the two-layered coating solution laminated before application readily undergoes a crosslinking reaction at the interface between the two solution, the extruded two solutions mixed near the die of the extrusion die coater readily undergoes thickening, which may interfere with the application procedure. Accordingly, when applying simultaneously as described above, it is preferable to apply the coating solution for a colorant-receiving layer (Coating Solution (A)) and the mordant solution (Coating Solution (B)) while allowing a barrier layer (intermediate layer solution) to be sandwiched between the two, whereby effecting a simultaneous three-layered coating.

A barrier layer solution may be any material. For example, an aqueous solution containing a trace amount of a water-soluble resin or water itself may be exemplified. Such a water-soluble resin is used as a thickening agent in view of the application performance, and may for example be a cellulose-based resin (for example, hydroxypropylmethyl cellulose, methyl cellulose, hydroxyethylmethyl cellulose and the like), polyvinyl pyrrolidone, gelatin and other polymers. The barrier layer solution may contain a mordant mentioned above.

After forming a colorant-receiving layer on a support, said colorant-receiving layer may be calendered through the roll nips under pressure with heating in a super calender, gloss calender and the like, whereby improving the surface smoothness, gloss, transparency and coating film strength. Nevertheless, since said calendering may cause a reduced % void volume (thus, a reduced ink absorption performance), it should be conducted under a condition which causes only a slight reduction in the % void volume.

The roll temperature of the calendering is preferably 30 to 150° C., more preferably 40 to 100° C./The inter-roll pressure at a contact line of the calendering is preferably 50 to 400 kg/cm, more preferably 100 to 200 kg/cm.

The thickness of a colorant-receiving layer described above should be determined in relation with the % void volume of the layer since an ink jet printing requires an absorption capacity sufficient to absorb all of the ink droplets. For example, a film whose layer thickness is about 15 μm or more is required when the ink amount is 8 nL/mm² and the % void volume is 60%.

Based on such requirements, the layer thickness of a colorant-receiving layer in an ink jet printing is preferably 10 to 50 μm;

The micropore size of a colorant-receiving layer, when represented as a median, is preferably 0.05 to 0.030 μm, more preferably 0.01 to 0.025 μm.

The % void volume and the micropore median size can be measured using a mercury porosimeter (trade name *PORESIZER 9320-PC2*, Shimadzu).

It is preferable that a colorant-receiving layer has an excellent transparency, the index of which is a haze value of the colorant-receiving layer formed on a transparent film support, which is preferably 30% or less, more preferably 20% or less.

Such a haze value can be measured using a haze meter (HGM-2DP, *SUGA SHIKENKI (KK)*).

To a constituent layer (for example, a colorant-receiving layer or back layer) of an ink jet printing sheet, a polymeric microparticle dispersion may be added. Such a polymeric microparticle dispersion is used for the purpose of improving the physical characteristics of the film, such as stabilizing the size and preventing the curls, deposition, film cracking and the like. The polymeric microparticle dispersion is discussed in JP-A-62-245258, 62-1316648 and 62-110066. Layer cracking or curling can be prevented by adding a polymeric microparticle dispersion having a low glass transition point (40° C. or below) to a layer containing a mordant described above. The curling can be prevented also by adding a polymeric microparticle dispersion having a high glass transition point to a back layer.

An ink jet printing sheet can be produced also by the methods described in JP-A-10-81064, JP-A-10-119423, JP-A-10-157277, Jr-A-10-217601, JP-A-11-348409, JP-A-2001-138621, JP-A-2000-43401, JP-A-2000-211235, JP-A-2000-309157, JP-A-2001-96897, JP-A-2001-138627, JP-A-11-91242, JP-A-8-2087, JP-A-8-2090, JP-A-8-2091, JP-A-8-2093.

The ink printed on an inventive printing sheet may be any ink for ink jet printing, which may be aqueous or oily ink containing any type of colorant.

### EXAMPLES

The invention is further detailed in the following Examples, which are not intended to restrict the invention. In the Examples, “part” and “%” are “part by weight” and “% by weight”, respectively, and “mean molecular weight” and “polymerization degree” are “mass mean molecular weight” and “mass mean polymerization degree”, unless otherwise indicated.

### Example 1

(Production of Support)

A pulp consisting of 100 parts of LBKP was refined to the level of 300 ml as a Canadian freeness using a double disc refiner, combined with 0.5 parts of an epoxy-derivatized behenic acid aside, 1.0 parts of an anion polyacrylamide, 0.1 parts of a polyamide polyamine epichlorohydrin and 0.5 parts of a cation polyacrylamide, all amount being on the basis of absolute dry mass ratio, weighed by a long-net papermaking machine to produce a original paper of 170 g/M².

In order to adjust the surface size of the original paper described above, a fluorescent whitening agent (Whitex BB manufactured by SUMITOMO CHEMICALS) was added at 0.04% in a 4% aqueous solution of polyvinyl alcohol, with which the original paper was impregnated at 0.5 g/m² as an absolute dry mass ratio, dried and then calendered to obtain a substrate paper whose density was adjusted a 1.05 g/ml.

The resultant substrate paper was subjected to a corona discharge treatment at the side of the wire (reverse surface), coated with a high density polyethylene to a thickness of 19 μm using an extruder to form a matt-surfaced resin layer (hereinafter the resin layer surface being referred to as the reverse surface). The resin layer on this reverse surface was further subjected to a corona discharge treatment, and coated with a dispersion of an 1:2 (mass ratio) mixture of antistatic aluminum oxide (*ALUMINA SOL* 100 manufacture by *NISSAN KAGAKU KOGYO*) and silicon dioxide (*SNOWTEX* manufacture by *NISSAN KAGAKU KOGYO*) in water to obtain 0.2 g/m² as an absolute dry mass.

Then the felt surface (front surface) on which no resin layer was provided was subjected to a corona discharge treatment, laminated with a low density polyethylene containing 10% anatase titanium oxide, a trace amount of ultramarine and 0.01% (per polyethylene) of a fluorescent whitening agent whose MFR (melt flow rate) was 3.8 using an extruder adjusted to give the film thickness of 29 μm to form a highly glossy thermoplastic resin layer on the front surface of the substrate (hereinafter, this highly glossy surface being referred to as a face side), whereby obtaining a support.

(Preparation of Coating Solution A for Colorant-Receiving Layer)

Among the components of the composition shown below, (1) a gas phase process silica microparticle, (2) an ion exchange water and (3) a “PAS-M-1”, were dispersed using a KD-P (*SINMARU ENTERPRISE*) at 10000 rpm for 20 minutes, and then a solution containing (4) a polyvinyl alcohol, (5) a boric acid, (6) a polyoxyethylene lauryl ether and (7) an ion exchange water was added, and the mixture was dispersed again at 10000 rpm for 20 minutes to obtain Coating Solution A for a colorant-receiving layer.

The mass ratio of the silica microparticle and the water-soluble resin (PB ratio=(1):(4)) was 4.5:1, and the pH of the Coating Solution A for a colorant-receiving layer was 3.5, exhibiting an acidic condition.

<Composition of Coating Solution A for a colorant-receiving
layer>

| | |
|---|---|
| (1) Gas phase process silica microparticle | 10.0 parts |
| (inorganic microparticle) (*LEOSEAL QS-30*, | |
| manufactured by TOKUYAMA) (KK), mean primary | |
| particle size: 7 nm) | |
| (2) Ion exchange water | 51.7 parts |
| (3) “PAS-M-1” (60% aqueous solution) | 0.83 parts |
| (Dispersing agent, manufactured by NITTOBO) | |
| (4) Polyvinyl alcohol (water soluble resin) | 27.8 parts |
| 8% Aqueous solution (PVA124 manufactured | |
| by KURARAY, saponification degree: 98.5%, | |
| Polymerization degree: 2400) | |
| (5) Boric acid (crosslinking agent) | 0.4 parts |
| (6) Polyoxyethylene lauryl ether | 1.2 parts |
| (Surfactant), (KAO, EMULGEN 109P, | |
| 10% aqueous solution, HLB value: 13.6 | |
| (7) Ion exchange water | 33.0 parts |

(Production of Ink Jet Printing Sheet)

After subjecting the face side of the support described above to a corona discharge treatment, the Coating Solution A for a colorant-receiving layer obtained as described above was applied at the coating rate of 200 ml/m² to the face side of the support using an extrusion die coater (coating step), and dried using a hot air drier at 80° C. (blowing rate of 3 to 8 m/second) until the % solid of the coating layer became 20%. During this period, the coating layer exhibited a constant rate drying velocity. Immediately after this period, the support was immersed in Mordant Solution B having the composition shown below for 30 seconds to deposit 20 g/m² onto the coating layer (mordant solution application step), and then dried at 80° C. for 10 minutes (drying step). As a result, an ink jet printing sheet R-1 according to the invention provided with a colorant-receiving layer whose dry film thickness was 32 μm was obtained.

<Composition of Mordant Coating Solution B>

| | |
|---|---|
| (1) Boric acid (crosslinking agent) | 0.65 parts |
| (2) Polyallylamine PAA-10C | 25 parts |
| 10% Aqueous solution (mordant, NITTOBO) | |
| (3) Ion exchange water | 59.7 parts |
| (4) Ammonium chloride (surface pH modifier) | 0.8 parts |
| (5) Polyoxyethylene lauryl ether | 10 parts |
| (Surfactant), (KAO, EMULGEN 109P, | |
| 2% aqueous solution, HLB value: 13.6 | |
| (6) *MEGAFAC* F1405, 10% Aqueous solution | 2.0 parts |

(DAINIPPON INK, Fluorine-Based Surfactant)

Ink jet printing sheets R-2 to R-8 having the composition similar to that of the ink jet printing sheet R-1 described above except for incorporating the following additives into the composition of R-1 were produced.

TABLE 1

| | Additives |
|---|---|
| R-1 (Comparative) | None |
| R-2 (Comparative) | 2.5 parts of POEP-1 to Coating |
| | Solution B for R-1 |
| R-3 (Comparative) | 2.5 parts of POEN-1 to Coating |
| | Solution B for R-1 |
| R-4 (Inventive) | 2.5 parts of W-1 to Coating Solution B |
| | for R-1 |
| R-5 (Inventive) | 2.5 parts of W-4 to Coating Solution B |
| | for R-1 |
| R-6 (Inventive) | 2.5 parts of W-6 to Coating Solution B |
| | for R-1 |
| R-7 (Inventive) | 2.5 parts of W-9 to Coating Solution B |
| | for R-1 |
| R-8 (Inventive) | 2.5 parts of W-11 to Coating Solution |
| | B for R-1 |
| R-9 (Inventive) | 2.5 parts of X-1 to Coating Solution B |
| | for R-1 |
| R-10 (Inventive) | 2.5 parts of X-4 to Coating Solution B |
| | for R-1 |
| R-11 (Inventive) | 2.5 parts of X-6 to Coating Solution B |
| | for R-1 |
| R-12 (Inventive) | 2.5 parts of X-9 to Coating Solution B |
| | for R-1 |
| R-13 (Inventive) | 2.5 parts of X-11 to Coating Solution |
| | B for R-1 |

Each of the ink jet printing sheets shown above was placed in the paper feeding area of EPSON ink jet printer Model PM-950C, and printed using an ink set of PM-950C a monochrome black letter image. Using this image, the image robustness under a highly humid condition was evaluated.

(Evaluation Experiment)

The blurring of the image under the highly humid condition was evaluated by the following procedure; thus, four 3 cm×3 cm squares were arranged in the form of the chinese character “ [symbol] ” while providing a blank gap of 1 mm between squares, and this image pattern was used as an image sample which was stored at 25° C. and 90% RE for 72 hours, after which the black dye blurring in the blank gaps was examined visually, and the results were judged as A when the increase in the black color intensity in the blank based on the intensity immediately after printing was 0.01 or less when observed using a Bk (black) filter of status A, as B when 0.01 to 0.05, and as C when 0.05 or higher.

The results are shown in Table 2.

TABLE 2

| | Black blurring |
|---|---|
| EPSON genuine PM photograph paper | C |
| R-1 (Comparative) | C |
| R-2 (Comparative) | C |
| R-3 (Comparative) | C |
| R-4 (Inventive) | A |
| R-5 (Inventive) | A |
| R-6 (Inventive) | A |
| R-7 (Inventive) | A |
| R-8 (Inventive) | A |
| R-9 (Inventive) | A |
| R-10 (Inventive) | A |
| R-11 (Inventive) | A |
| R-12 (Inventive) | A |
| R-13 (Inventive) | A |

Based on the results shown in Table 2, it was revealed that all of the inventive ink jet printing sheets were superior to all Comparatives in terms of the black blurring.

On the other hand, the similar evaluation was conducted using a mordant polyallylamine PAA-10C which contained 2* unreacted monomer (molecular weight:500 or less), and the results indicated that the blurrings of R-4 to R-13 were all judged as B. These findings also served to reflect the effect of the invention.

According to the invention, an ink jet printing sheet exhibiting a reduced image blurring even under a highly humid condition can be obtained.

This application is based on Japanese Patent application JP 2003-2310, filed Jan. 8, 2003, and Japanese Patent application JP 2003-2312, filed Jan. 8, 2003, the entire contents of those are hereby incorporated by reference, the same as if set forth at length.

What is claimed is:

1. An ink jet printing sheet comprising a colorant-receiving layer and a support, wherein the colorant-receiving layer contains a metal chelating compound having an oil-soluble group having 6 or more carbon atoms or an amino acid derivative having an oil-soluble group having 6 or more carbon atoms.

2. The ink jet printing sheet according to claim 1 wherein the colorant-receiving layer further comprises a water-soluble resin.

3. The ink jet printing sheet according to claim 2, wherein the water-soluble resin is at least one selected from a polyvinyl alcohol resin, a cellulose resin, a resin having an ether bond, a resin having a carbamoyl group, a resin having a carboxyl group and gelatins.

4. The ink jet printing sheet according to claim 1, wherein the colorant-receiving layer further comprises a microparticle.

5. The ink jet printing sheet according to claim 4, wherein the microparticle is at least one selected from a silica microparticle, a colloidal silica, an alumina microparticle and a pseudo-boehmite.

6. The ink jet printing sheet according to claim 2, wherein the colorant-receiving layer further comprises a crosslinking agent capable of crosslinking the water-soluble resin.

7. The ink jet printing sheet according to claim 1, wherein the colorant-receiving layer further comprises a mordant.

8. The ink jet printing sheet according to claim 1, wherein the colorant-receiving layer is a layer formed as a result of a crosslinking curing of a coating layer formed. by applying a coating solution comprising at least a microparticle, a water-soluble resin and a crosslinking agent; and the crosslinking curing is conducted by applying a basic solution whose pH is B or higher onto the coating layer or a coating film (1) simultaneously with the application of the coating solution, or (2) during a course of a drying of the coating layer formed by applying the coating solution but before a time when the coating layer exhibits a reduced rate drying.
